(19) United States
(12) Patent Application Publication
(10) Pub. No.: US 2003/0220036 A1
(43) Pub. Date: Nov. 27, 2003

(54) Laminates and coated materials comprising hydroxy-phenoxyether polymers

(76) Inventors: Robert A. Lee, View Bowdon (GB); Gerald A. Hutchinson, Coto de Caza, CA (US); Basharat A. Nazir, Wycombe (GB); Charles P. Klass, Radnor, PA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/168,496

(22) PCT Filed: Dec. 20, 2000
(86) PCT No.: PCT/US00/34747

(51) Int. Cl. B32B 3/00; B32B 5/02; B32B 9/00

(52) U.S. Cl. 442/153; 442/381; 442/385; 442/413; 442/370; 442/295

(57) ABSTRACT

Disclosed are laminates and coated materials, such as coated paper, and methods for making same utilizing hydroxy-phenoxyether polymers. In preferred embodiments, the laminates and coated materials of this invention are recyclable and/or are made, at least in part, from recycled materials.

### FIELD OF THE INVENTION

This invention relates to laminates and coated materials, such as coated paper, and methods for making same utilizing hydroxy-phenoxyether polymers. In preferred embodiments, the laminates and coated materials of this invention are recyclable and/or are made, at least in part, from recycled materials.

### BACKGROUND OF THE INVENTION

Description of the Related Art

Large quantities of material are used for packaging throughout the world. The bulk of packaging is used to contain, protect and identify its contents in a single journey, and hence finishes up in trade or domestic refuse, resulting in environmental and economic concerns. Traditional raw materials such as glass, metals, plastics and paper are used in many one-use food and drink packaging applications. However, each has its own disadvantages.

Glass is a relatively cheap raw material, but its processing is energy intensive and recycling may be difficult due to the incompatibility of different colored glasses. Another disadvantage of using glass as a packaging material is the high potential for breakage and the resultant safety issues. Metals are a relatively expensive raw material and processing costs are high. However, recycling reduces these costs and sorting may be achieved relatively easily. Petroleum-based plastics are a widely used packaging material replacing both glass and metal, however such packaging is expensive to manufacture and relatively difficult to recycle.

Paper and paperboard are the cheapest and most extensively used raw materials. Paper is the most technologically advanced material in the area of recycling, but some applications as a packaging material for food and drink products are limited by its chemical and physical properties. The main disadvantage is that paper and paperboard absorb moisture not only from contact with a liquid, but also from a humid atmosphere. Conventional papers normally absorb moisture to a considerable extent. The result is that the paper becomes soft, easy to tear and may disintegrate with spoilage of the product it is trying to protect.

Different approaches have been proposed for improving the strength of paperboard and containerboard. For example, U.S. Pat. No. 6,114,471 teaches the use of lignosulfonate to improve the strength of containerboard and other paperboard, claiming substantial reduction or elimination of the bleeding of strengthening agents from the paperboard when touched with wet hands or contacted under humid conditions. However, the use of lignosulfonate darkens linerboard, significantly interfering with the visual appeal and appearance of corrugated containers and other products made from the treated paperboard.

Addition of sizing and wet strength agents and coating with waxes may enhance the moisture-resistance of paper and paperboard and help retain strength. Such treatments produce a long lasting paper that maintains its integrity over periods of storage and repeated handling. However, no single component may enhance both strength and moisture resistance and many traditional additives are difficult to recycle. Thus, an additive or coating that enhances moisture resistance, improves strength and has the potential to be recycled is desirable.

In packaging fresh fruit and vegetables, there is a need for reinforcement of the paperboard or corrugated board to give the necessary tensile and compressive strength under conditions of high humidity. If compressive strength is lacking, then a stack of boxes may collapse under its own weight. Spirally-wound tubes and containers also require high physical integrity under moist conditions.

Another application is the incorporation of a polymeric material into pulp-molded products such as egg-boxes, container partitions, and corner protectors so as to improve impact-resistance and stacking strength as well as water, oil and grease resistance. Protective packaging, for example, of electrical and consumer goods, requires high levels of impact resistance. Existing molded pulp products absorb the energy of drop impacts through crushing. This limits the usefulness of the product where multiple drop performance is required. Materials such as polystyrene foam provide such protection but are not considered environmentally friendly. Thus, molded fiber products incorporating a component to provide improved resilient energy absorption without wall buckling, i.e., compressive failure of the packaging, and that permits acceptable multiple drop performance would be desirable.

Applications requiring liquid packaging having high levels of moisture barrier include milk, fruit juice, and decorative emulsion paints. Many packaging applications, for example dairy products, also require oil and grease resistance to prevent outward spoilage of the carton or container by fatty material migrating outward from the contents. Foods such as baked goods require an element of oil and grease resistance and ‘breathability’ to allow controlled changes in moisture content and the preservation of freshness and crispness. At the other extreme, gas barrier properties may be needed to prevent ingress of oxygen or egress of a protective atmosphere such as carbon dioxide or nitrogen gas. Cooked meat packaging is an example of this. At present, polymer films dominate this market, but a cellulosic composite material possessing the appropriate properties would be desirable.

Taint and odor protection constitutes a further application of barrier coating technology. This may be a two-way process, either to protect the contents from external contaminants or to preserve the flavors and aromas of the contents of the package, as in packaging tobacco, coffee, or tea.

Aluminum foil may be laminated to paper to provide very high levels of barrier integrity, but this creates recycling problems in separation of foil from fiber.

Moisture resistance may be conferred by laminating paper or paperboard with a polyolefin film. This approach also causes major problems in recycling the combined material. In some jurisdictions, there is pressure to use aqueous dispersions as barrier coats, since films made from these materials may be more readily dispersed when the fiber is recycled. This trend is likely to spread, not least because it also offers greater flexibility in pack design. Thus, a coating material that offers recyclability without unacceptable loss of fiber performance is desirable.

Hydroxy-phenoxyether polymers are known, see e.g. U.S. Pat. Nos. 6,011,111; 5,834,078; 5,814,373; 5,464,924: and 5,275,853; see also PCT Application Nos. WO 99148962; WO 99112995; WO 98129491; and WO 98114498. However, these disclosures do not address the aforementioned problems.

This invention provides a solution to these and other problems by describing how to prepare coated substrates and laminates comprising hydroxy-phenoxyether polymers. In preferred embodiments, these polymers impart higher tensile and compressive strength under conditions of high humidity, provide high levels of moisture barrier, improve impact-resistance, or provide greater recyclability of the components of the coated substrates and laminates.

### SUMMARY OF THE INVENTION

In preferred embodiments of the present invention, coated substrates and laminates and methods for coating or impregnating materials to be used in packaging materials are provided. The materials may include any suitable substrate, for example, cellulose or other fibers, in sheet or molded form, to be used in packaging materials with a hydroxy-phenoxyether polymer such as polyhydroxy-amino ether (PHAE) to enhance moisture resistance and increase strength.

A preferred embodiment takes advantage of the cheap cellulose raw material and enhances its performance in the use of packaging for food, drink and pharmaceutical product, while making use of existing manufacturing technology. The fibrous paper or board sheet is coated/laminated with a hydroxy-phenoxyether polymer, for example, PHAE sold as BLOX® by the Dow Chemical Company, to impart strength and act as a moisture and oxygen barrier thereby extending the use of cheap cellulose fiber in packaging product.

The coated substrates and laminates containing hydroxy-phenoxyether polymer of the preferred embodiments have the potential to be recycled, thus packaging products of this kind do not contribute to the landfill burden. Hydroxy-phenoxyether polymer may also be recovered from the outside of polyethylene terephthalate (PET) plastic bottles and other non-paper containers on which it is coated and reused in the coating/laminating of paper and boards. The hydroxy-phenoxyether polymers of preferred embodiments have adhesive properties, are useful as barrier coating for water, oil, grease, vapor and gas resistance, impart mechanical and structural strength, and may be applied to a substrate in either thermoplastic resin, dispersion or solution form.

These and other embodiments are described in greater detail below.

### BRIEF DESCRIPTION OF THE DRAWINGS

FIG. 1 is a flow chart showing a summary of preferred processes for preparing materials containing hydroxy-phenoxyether polymers.

FIG. 2 is a flow chart and equipment list for a typical papermaking process.

FIGS. 3a-d illustrate schematic diagrams of four preferred embodiments of roll coaters.

FIGS. 4a and 4b provide schematic diagrams of a preferred blade coater and a preferred air knife coater.

FIG. 5 is a schematic diagram of a simple short dwell coater.

FIG. 6 is a chart summarizing the various end use applications of materials according to the present invention.

FIG. 7 is a chart illustrating the recycling process for articles made with hydroxy-phenoxyether polymers and fibers.

FIG. 8 is a chart illustrating the recycling process for paper products made with hydroxy-phenoxyether polymers.

### DETAILED DESCRIPTION OF THE PREFERRED EMBODIMENTS

Introduction

The following description and examples illustrate the preferred embodiment of the present invention in detail. Those of skill in the art may recognize that there are numerous variations and modifications of this invention that are encompassed by its scope. Accordingly, the description of the preferred embodiment should not be deemed to limit the scope of the present invention.

The term ‘hydroxy-phenoxyether polymer’, as used herein, is a broad term and is used in its ordinary sense, including, without limitation, a polymer having aromatic ether moieties in its backbone chain and pendant hydroxyl groups, see e.g. U.S. Pat. No. 6,011,111 (incorporated herein by reference in its entirety). In the descriptions herein, composites and materials comprising hydroxy-phenoxyether polymers may also be made with other thermoplastic phenoxies and epoxies.

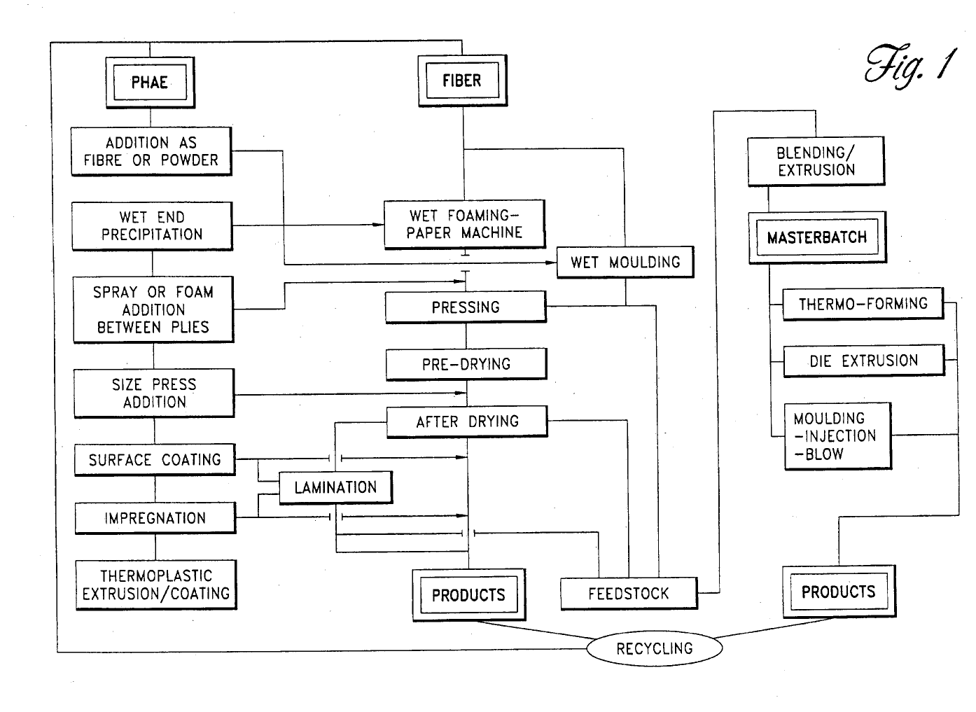

Hydroxy-phenoxyether polymers are a versatile family of products which may be dissolved in a solution of water with acetic or phosphoric acid. Hydroxy-phenoxyether polymers may act as wet strength agents in paper and may be deposited and integrated into a slurry pulp solution to make a polymer/fiber composite. Polymer/fiber composites, such as coated substrates and laminates, are preferably created by plastisol coating methods, nonaqueous solution or dispersion coating methods, dry coating methods, and lamination methods. Hydroxy-phenoxyether polymers impart mechanical strength and water resistance to structured pulp and paper products, and other polymer fiber composites. Polymer/fiber composites may be foamed in the presence of steam and/or starch or other materials. Lower densities may be achieved by using chemical blowing agents or physical blowing agents. A flow chart showing a summary of preferred processes for preparing materials containing hydroxy-phenoxyether polymers is provided in FIG. 1.

In preferred embodiments wherein the substrate comprises fibers, the hydroxy-phenoxyether polymer may be incorporated into a substrate by intermixing the polymer with the fibers. The term ‘intermixing’, as used herein, is a broad term and is used in its ordinary sense, including, without limitation, all manner of applying, mixing, coating and/or spraying the hydroxy-phenoxyether polymer (or mixture containing the polymer) with or onto fibrous material, such as, for example, cellulosic material, to form an admixture that comprises the polymer and the cellulosic material. Thus, the resulting admixture may but need not be a heterogeneous or homogeneous physical mixture of cellulosic material and hydroxy-phenoxyether polymer. The admixture may be in the nature of a layer or coating of hydroxy-phenoxyether polymer on the cellulosic material.

The term ‘cellulosic material,’ as used herein, is a broad term that is used in its ordinary sense to include, without limitation, all manner of cellulose-containing compositions, including pulp slurry, the paper web that is formed during the papermaking process, the concentrated pulp slurry used in the pulp molding process, wet paper, and dry paper. Additionally, although the description often refers directly to the use of cellulosic fibers, it should be understood that other fibers including, but not limited to, non-wood fibers, such as vegetable fibers like flax, coir and hemp, and fibers made of metals, composites, and glass may be used in place of cellulosic fibers. The fibers used may be of any practicable length. Furthermore, in this description, reference to paper should not be read to exclude the use of other fabrics, sheets and articles made from fibers.

Certain preferred embodiments relate to paper comprising a hydroxy-phenoxyether polymer and methods of making such paper. The term ‘paper’, as used herein, is a broad term and is used in its ordinary sense, including, without limitation, all manner of processed or molded cellulosic materials and thus includes all types of paper products produced from a cellulosic pulp slurry, including without limitation intermediate paper fiber products, finished products such as thin sheets of paper used for documents, books, newspapers, magazines and the like and heavier grades of paper such as cardboard, multi-ply paper, paper laminates, coated paper, corrugated paper, and paper used for packaging, shipping containers and the like, without limitation.

The paper described herein may be shaped, processed or incorporated into semi-finished or finished manufactured items such as writing paper, drawing paper, paper towels, tissues, containers (e.g., paper bags, paper boxes, cardboard boxes, mailing tubes, file folders), photo paper, glossy paper, cardboard, corrugated cardboard, disposable diapers, adhesive labels, honeycomb-like structures (e.g., cellular structures having open or closed cells of one or more shapes, including without limitation hexagonal, polygonal, and/or rounded shapes), sandpaper, and packaging material, by processes and methods generally known to those skilled in the art.

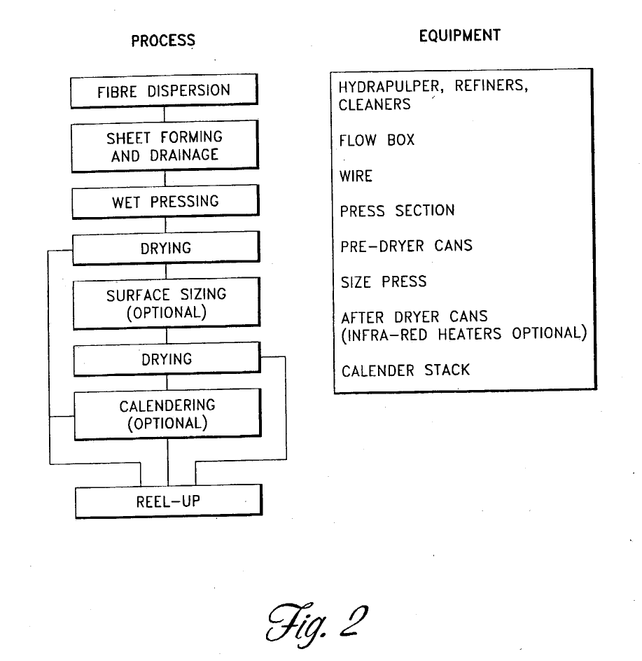

The term ‘pulp slurry’, as used herein, is a broad term and is used in its ordinary sense, including, without limitation, an aqueous slurry containing cellulose or cellulosic fiber derived from a plant or wood pulping process or paper recycling process, regardless of whether such cellulose is derived from plants such as cotton or from hardwood or softwood or combinations thereof, and regardless of whether the pulping process(es) employed to provide such slurry is categorized as a mechanical or chemical or secondary or hybrid pulping process, or whether the slurry is derived from a plurality of types of pulping processes, and regardless of whether or not the pulp, or part of the pulp, has been bleached. A flow chart and equipment list for a typical papermaking process is provided in FIG. 2.

In preferred embodiments, the hydroxy-phenoxyether polymers are used in paper or paperboard packaging. To meet the many packaging specifications of the food, drink, and pharmaceutical industries, many different types of such packaging are required, each having different grammages and surface properties. The application of the hydroxy-phenoxyether polymer to, for example, a cellulose sheet therefore needs to be a versatile process so that the application produces a cellulosic product that meets the required packaging specification and has a functional performance that may be modified in accordance with the end-use requirements.

The hydroxy-phenoxyether polymer may be combined with cellulosic fibers at any stage of the paperboard manufacturing process, including addition to the fiber prior to forming or molding: spraying on to the wet sheet surface on the paper or paperboard machine; spraying between the plies of a multi-ply paper board; surface addition at the size-press of the paper or board machine; surface coating either on the paper or board machine or off-line in an intermediate process; foam application with stabilizers and fillers at any convenient stage of the manufacturing process; lamination of two or more sheets with the hydroxy-phenoxyether polymer added between the sheets by coating, spraying or foam addition; pressure or dip impregnation of hydroxy-phenoxyether polymer solution into preformed cellulose we sheet or molded article.

The use of hydroxy-phenoxyether polymer to improve strength properties of paperboard involves the addition of polymer to the fiber by wet precipitation from solution/dispersion, as a powder or fiber, or by impregnation of the preformed sheet. The precipitation method is convenient, especially for the production of pulp-molded materials. Addition of polymer powder or polymer fiber may require additional process chemicals, such as the retention aids familiar to the paper and board industry. The powder may be added to the pulp white water or the paper machine backwater. Alternatively, the polymer may be added by spraying onto the paper machine wire or by spraying between the paper plies in a multi-ply machine. Spraying may also be used to apply aqueous or nonaqueous dispersions or solutions of the hydroxy-phenoxyether polymer.

The hydroxy-phenoxyether polymer fiber may be added to the fiber supply, for example, in a machine chest or holding tank. The hydroxy-phenoxyether polymer powder or fiber is then fused to the cellulose during the passage of the paper or paperboard through the drying section of the machine. Addition by any of these methods improves ply bond, burst, compressive and tensile strength.

The hydroxy-phenoxyether polymer may also be applied to paperboard as suspension, dispersion or solution by a foam coating process instead of spraying. The foam would be sandwiched between two or more paper layers to produce a laminated structure. Impregnation of a pre-dried sheet makes more efficient use of the natural bonding properties of the cellulosic fiber and permits some control of the distribution of polymer through the thickness of the sheet. This would be done either at the size-press or as an off-line process.

In applications where high barrier integrity is not required, such as in the development of water and grease resistance with ‘breathable’ coatings, size press application on the paper machine is suitable. The size press also offers some impregnation of the hydroxy-phenoxyether polymer into the sheet for the improvement of strength properties. This is useful in the production of label stock and map papers where strength and water resistance are important.

Both standard ‘puddle’ size presses and metering size presses may be used. Puddle size presses may be used on slower paper machines and may impart strength improvements together with oil and grease resistance. Metering size presses may give less penetration, and therefore less strength improvement but higher film forming and barrier performance. Such presses are found on larger and higher-speed machines. Size press treatment may be used to provide a single functional coat or a ground-coat for further coating applications later, as in the production of base stock for silicone release papers. Platy clays or similar minerals capable of reducing permeability of the surface coating may be incorporated in the hydroxy-phenoxyether polymer formulation to improve cost-effectiveness of the coating.

Coating/laminating with hydroxy-phenoxyether polymer is possible with many existing coating technologies, which enables many packaging specifications to be met as each coating process has an optimum set of operating conditions, such as viscosity, web speed and sheet grammage. In food, drink, and pharmaceutical packaging, barrier properties are generally of great importance, however the barrier qualities of a given material may vary depending on the gas being permeated through the material. For example, high-density polyethylene (HDPE) is a moisture barrier but a poor oxygen barrier, and PET is only a fair moisture barrier but a good oxygen barrier. Oxygen and water vapor are the two most common barrier functions, as these are the gases most responsible for product degradation. The polymer films need to maintain their integrity with no pinholes or thin areas in their structure.

Table 1 summarizes application methods versus product characteristics

TABLE 1
Paper Applications

| | | Water | | Impreg- | |
|---|---|---|---|---|---|
| | Water & | Vapor & Gas | Adhesive | nation | |
| | Grease | Barrier | Lamina- | For | Master |
| Application | Resistance | Properties | tion | Strength | Batch |
| Wet End | — | — | — | x | x |
| Size Press | x | — | — | some | some |
| Roll Coating | x | x | x | — | x |
| Metering | | | | | |
| Blade | x | x | — | — | — |
| Rod | x | x | x | — | — |
| Air Knife | x | x | — | — | — |
| Pressure | x | some | — | x | x |
| Saturation | | | | | |
| Spray or | x | — | x | — | some |
| foam * | | | | | |
| Extrusion | x | x | x | — | — |
| Coating | | | | | |
| Extrusion | x | x | x | — | — |
| Lamination | | | | | |

* To surface or between plies of multi-ply boards

The addition methods outlined in Table 1 may be used not only to manufacture marketable products but also to prepare master batches for the preparation of thermoplastic composite materials from hydroxy-phenoxyether polymer and cellulosic fiber. The method of primary addition of hydroxy-phenoxyether polymer to cellulosic fiber would be chosen according the operational convenience, cost and the desired ratio of polymer to cellulosic fiber. The intermediate product may be a laminar composite capable of being molded into three-dimensional shapes by the application of heat and pressure in a thermoforming process.

The Hydroxy-Phenoxyether Polymer

The hydroxy-phenoxyether polymers of preferred embodiments are polymers having aromatic ether moieties in their backbone chains and pendant hydroxyl groups. One hydroxy-phenoxyether polymer of a preferred embodiment is polyhydroxy amino ether (PHAE). PHAE has the simple repeating formula shown below and has a molecular weight of 40,000 to 60,000.

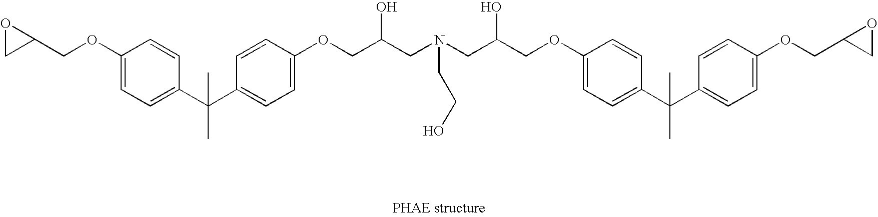

The chains contain two nitrogen atoms in amine groups available for neutralization with acetic, phosphoric or another non-oxidizing acid to make the polymer soluble in water. The other features of the molecular structure are epoxy groups, which are available for cross-linking reactions with cellulose, starch or other carbohydrates.

Polymers or resins containing epoxy groups are already used in the paper and board industry to provide ‘wet strength’, i.e., retention tensile strength under moist conditions. These prior art materials are typified by the polyamine amide epichlorhydrin (PAE), polyamino epichlorhydrin and polyamide epichlorhydrin epoxide resins. Once reacted with a cellulosic fiber, these materials are thermosetting, rigid and insoluble. Other thermosetting resins used for similar purposes include the aminoplast resins, such as, for example, urea-formaldehyde (UF) and melamine formaldehyde (MF) resins, and glyoxal resins such as glyoxalated polyacrylamide (GPAM). In comparison with these materials, hydroxy-phenoxyether polymers offer the advantages of thermoplasticity, i.e., materials formed from them may be deformed reversibly under heat and pressure; toughness, i.e., not brittle and capable of absorbing shock loads; recyclable, i.e., the resins may be readily re-solubilized and the resin containing materials may be broken up; and formaldehyde-free.

Compared with other thermoplastic materials having similar structural properties, such as polyethylene, polypropylene, and polystyrene, the hydroxy-phenoxyether polymers are melt-stable, water-dispersible, and hydrophilic and react readily with cellulose on drying. However, they also have good gas and water vapor barrier properties. Films prepared from hydroxy-phenoxyether polymers have oxygen transmission rates of 0.05 to 1.0 cm³/mil/100in²/atmospheres/day at 25° C. and 60% relative humidity (ASTMS D-3985). Carbon dioxide transmission rates are 0.5 to 4.0 cm³/mil/100in²/atmospheres/day at 23° C. and 0% relative humidity. It is this combination of thermoplasticity, barrier properties, adhesion to cellulose and cross-linking functionality that makes the hydroxy-phenoxyether polymers so versatile in their applications.

Full details of the composition of PHAE resins and monomer formulations is found in PCT application WO00/01750 published Jan. 13, 2000, entitled THERMALLY STABLE POLYETHERAMINES and assigned to The Dow Chemical Company of Midland, Mich. This application also describes the results of the barrier and thermal stability of PHAE resins.

Other preferred hydroxy-phenoxyether polymers include, but are not limited to, the following:

(1) hydroxy-functional poly(amide ethers) having repeating units represented by any one of the Formulae Ia, Ib or Ic:

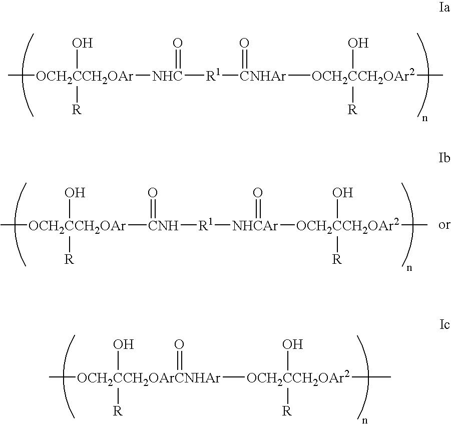

(2) poly(hydroxy amide ethers) having repeating units represented independently by any one of the Formulae IIa, IIb or IIc:

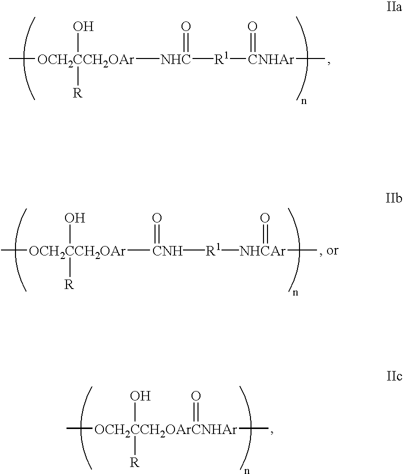

(3) amide- and hydroxymethyl-functionalized polyethers having repeating units represented by Formula III:

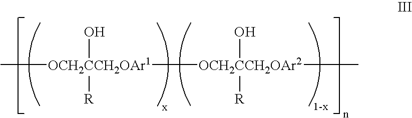

(4) hydroxy-functional polyethers having repeating units represented by Formula IV:

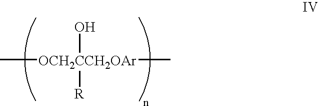

(5) hydroxy-functional poly(ether sulfonamides) having repeating units represented by Formulae Va or Vb:

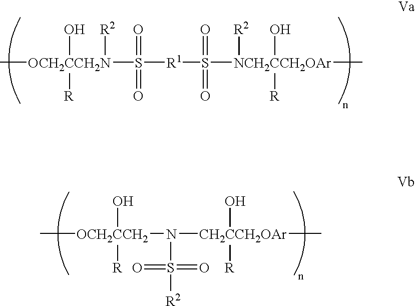

(6) poly(hydroxy ester ethers) having repeating units represented by Formula VI:

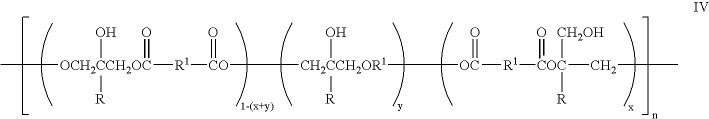

(7) hydroxy-phenoxyether polymers having repeating units represented by Formula VII:

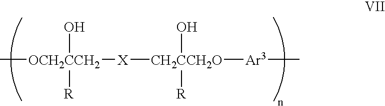

and

(8) poly(hydroxyamino ethers) having repeating units represented by Formula VIII:

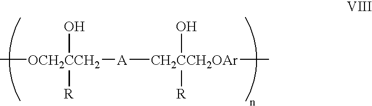

wherein each Ar individually represents a divalent aromatic moiety, substituted divalent aromatic moiety or heteroaromatic moiety, or a combination of different divalent aromatic moieties, substituted aromatic moieties or heteroaromatic moieties; R is individually hydrogen or a monovalent hydrocarbyl moiety; each Ar₁ is a divalent aromatic moiety or combination of divalent aromatic moieties bearing amide or hydroxymethyl groups; each Ar₂ is the same or different than Ar and is individually a divalent aromatic moiety, substituted aromatic moiety or heteroaromatic moiety or a combination of different divalent aromatic moieties, substituted aromatic moieties or heteroaromatic moieties; R₁ is individually a predominantly hydrocarbylene moiety, such as a divalent aromatic moiety, substituted divalent aromatic moiety, divalent heteroaromatic moiety, divalent alkylene moiety, divalent substituted alkylene moiety or divalent heteroalkylene moiety or a combination of such moieties; R₂ is individually a monovalent hydrocarbyl moiety; A is an amine moiety or a combination of different amine moieties; X is an amine, an arylenedioxy, an arylenedisulfonamido or an arylenedicarboxy moiety or combination of such moieties; and Ar₃ is a ‘cardo’ moiety represented by any one of the Formulae:

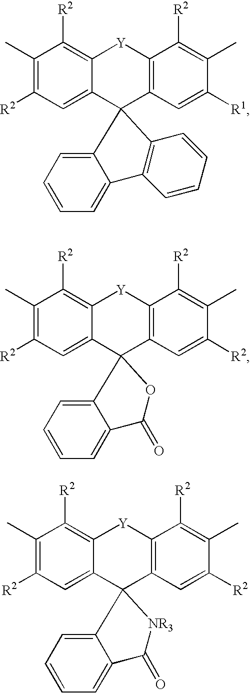

wherein Y is nil, a covalent bond, or a linking group, wherein suitable linking groups include, for example, an oxygen atom, a sulfur atom, a carbonyl atom, a sulfonyl group, or a methylene group or similar linkage; R¹ and R² are independently hydrogen, halogen, a hydrocarbyl or substituted hydrocarbyl, wherein hydrocarbyl is a monovalent hydrocarbon such as alkyl, cycloalkyl, aralkyl, or aryl and the substituent(s) is a monovalent moiety which is inert in the reactions used to prepare the polymer; and R₃ is hydrogen, a hydrocarbyl or substituted hydrocarbyl wherein hydrocarbyl is as defined previously and the substituent(s) is also as defined previously. Examples of such substituents include hydroxy, cyano and halo moieties. Preferably, n is an integer from about 10 to about 1000; x is 0.01 to 1.0; and y is 0 to 0.5.

The term ‘predominantly hydrocarbylene’, as used herein, is a broad term and is used in its ordinary sense, including, without limitation, a divalent radical that is predominantly hydrocarbon, but which optionally contains a small quantity of a heteroatomic moiety such as oxygen, sulfur, imino, sulfonyl, sulfoxyl, and the like.

The hydroxy-functional poly(amide ethers) represented by Formula I are preferably prepared by contacting an N,N′-bis(hydroxyphenylamido)alkane or arene with a diglycidyl ether as described in U.S. Pat. Nos. 5,089,588 and 5,143,998 (both incorporated herein by reference in their entirety).

The poly(hydroxy amide ethers) represented by Formula II are prepared by contacting a bis(hydroxyphenylamido)alkane or arene, or a combination of 2 or more of these compounds, such as N,N′-bis(3-hydroxyphenyl) adipamide or N,N′-bis(3-hydroxyphenyl)glutaramide, with an epihalohydrin as described in U.S. Pat. No. 5,134,218 (incorporated herein by reference in its entirety).

The amide- and hydroxymethyl-functionalized polyethers represented by Formula III may be prepared, for example, by reacting the diglycidyl ethers, such as the diglycidyl ether of bisphenol A, with a dihydric phenol having pendant amido, N-substituted amido and/or hydroxyalkyl moieties, such as 2,2-bis(4-hydroxyphenyl)acetamide and 3,5-dihydroxybenzamide. These polyethers and their preparation are described in U.S. Pat. Nos. 5,115,075 and 5,218,075 (both incorporated herein by reference in their entirety).

The hydroxy-functional polyethers represented by Formula IV may be prepared, for example, by allowing a diglycidyl ether or combination of diglycidyl ethers to react with a dihydric phenol or a combination of dihydric phenols using the process described in U.S. Pat. No. 5,164,472. Alternatively, the hydroxy-functional polyethers are obtained by allowing a dihydric phenol or combination of dihydric phenols to react with an epihalohydrin by the process described by Reinking, Barnabeo and Hale in the Journal of Applied Polymer Science, Vol. 7, p. 2135 (1963) (both the patent and journal article of this paragraph are incorporated herein by reference in their entirety).

The hydroxy-functional poly(ether sulfonamides) represented by Formula V are prepared, for example, by polymerizing an N,N′-dialkyl or N,N′-diaryldisulfonamide with a diglycidyl ether as described in U.S. Pat. No. 5,149,768 (incorporated herein by reference in its entirety).

The poly(hydroxy ester ethers) represented by Formula VI are prepared by reacting diglycidyl ethers of aliphatic or aromatic diacids, such as diglycidyl terephthalate, or diglycidyl ethers of dihydric phenols with, aliphatic or aromatic diacids such as adipic acid or isophthalic acid. These polyesters are described in U.S. Pat. No. 5,171,820 (incorporated herein by reference in its entirety).

The hydroxy-phenoxyether polymers represented by Formula VII are prepared, for example, by contacting at least one dinucleophilic monomer with at least one diglycidyl ether of a cardo bisphenol, such as 9,9-bis(4-hydroxyphenyl)fluorene, phenolphthalein, or phenolphthalimidine or a substituted cardo bisphenol, such as a substituted bis(hydroxyphenyl)fluorene, a substituted phenolphthalein or a substituted phenolphthalimidine under conditions sufficient to cause the nucleophilic moieties of the dinucleophilic monomer to react with epoxy moieties to form a polymer backbone containing pendant hydroxy moieties and ether, imino, amino, sulfonamido or ester linkages. These hydroxy-phenoxyether polymers are described in U.S. Pat. No. 5,814,373 (incorporated herein by reference in its entirety).

The poly(hydroxyamino ethers) (‘PHAE’ or polyetheramines) represented by Formula VII are prepared by contacting one or more of the diglycidyl ethers of a dihydric phenol with an amine having two amine hydrogens under conditions sufficient to cause the amine moieties to react with epoxy moieties to form a polymer backbone having amine linkages, ether linkages and pendant hydroxyl moieties. These compounds are described in U.S. Pat. No. 5,275,853 (incorporated herein by reference in its entirety).

Thermoplastic phenoxy materials suitable for use in the preferred embodiments of this invention include those commercially available from Phenoxy Associates, Inc. These hydroxy-phenoxyether polymers are the condensation reaction products of a dihydric polynuclear phenol, such as bisphenol A, and an epihalohydrin and have the repeating units represented by Formula IV wherein Ar is an isopropylidene diphenylene moiety. A process for preparing these is described in U.S. Pat. No. 3,305,528 (incorporated herein by reference in its entirety).

Phenoxy-type thermoplastics of Formulae I-VIII may be obtained commercially from Dow Chemical Company. The most preferred hydroxy-phenoxyether polymers are the poly(hydroxyamino ethers) (‘PHAE’ or polyetheramines) represented by Formula VII, such as XU19040.00L or BLOX 0005 available from The Dow Chemical Company.

Additional components may also be added to the hydroxy-phenoxyether polymer to enhance its coating properties. Two categories of additives are preferred, process aids and product additives. Examples of process aids include rheology modifiers or thickeners, calender lubricants, and biocides. Additional components may be present as well, including but not limited to, dyes, filler materials, blowing agents, emulsifiers, flame retardants, hardeners, plasticizers, and the like. Process additives may be used to improve the efficiency of the coating operations, for example, by controlling coatweight and uniformity or by preventing microbial attack. Product additives may be used to improve the performance of the product. For example, crosslinking agents tend to increase the rigidity and water resistance of the product. Examples of product additives are optical brightening agents, crosslinking agents, plasticizers, dyes, fillers, anti-static agents, anti-slip or anti-tack agents and flame retardants. They also include materials such as aminoplast, epihalohydrin or glyoxal resins and inorganics such as zirconium compounds. Plasticizers may include low T_{g} (glass transition temperature) acrylic or vinyl resins to improve flexural properties, provided that these additives are readily miscible with the parent resin. Examples of such plasticizers include sorbitol and glycerol.

In many cases, thickening agents or rheology modifiers are used to improve the coverage and uniformity of coatings applied to substrates comprising papers. The performance of hydroxy-phenoxyether polymer as a barrier coating may be improved by the addition of platy clays, preferably at a level below the critical pigment volume concentration. After coating, the coated paper may be calendered to improve surface smoothness.

The order and manner of addition of the ingredients is preferably controlled to avoid gross precipitation of the hydroxy-phenoxyether polymer from solution or sudden increases in viscosity. A high-shear mixer is preferably used, but caution should be exercised to avoid shearing the polymer to the extent that the viscosity and effectiveness of the coating are reduced. The additives should also be compatible with solvent used to prepare the dispersion or solution. Suitable nonaqueous solvents include, but are not limited to, acetone and liquid carboxylic acids such as acetic acid.

While virgin or non-recycled hydroxy-phenoxyether polymer may be used in the coating and lamination methods of the preferred embodiments, virgin hydroxy-phenoxyether polymer containing a percentage of recycled hydroxy-phenoxyether polymer, or 100% recycled hydroxy-phenoxyether polymer may also be used. Preferably, the hydroxy-phenoxyether polymer comprises at least 5% or more recycled hydroxy-phenoxyether polymer, more preferably at least 10% or more recycled hydroxy-phenoxyether polymer, most preferably at least 20, 30, 40, or 50% or more recycled hydroxy-phenoxyether polymer. By using hydroxy-phenoxyether polymer containing at least some recycled hydroxy-phenoxyether polymer, cost savings may be achieved over using 100% virgin hydroxy-phenoxyether polymer.

Substrates

The substrates that may be coated in accordance with preferred embodiments include any substrate wherein a hydroxy-phenoxyether polymer may be bonded to the substrate. The bond between coating and substrate may be formed due to the adhesive properties of the hydroxy-phenoxyether polymer of the coating, the adhesive properties of the substrate, or by participation of a third component in the bonding process.

In preferred embodiments, the substrate may include mineral fibers, such as, for example, asbestos, synthetic fibers, such as, for example, rayon or nylon, ceramics, metals, glass, polymers, cellulosics, and other materials. Suitable synthetic polymers include, but are not limited to, synthetic polar polymers such as polyethylene terephthalate and nylon. In a particularly preferred embodiment, the substrate is a material comprising cellulosic fibers.

For many substrates, suitable adhesion between the substrate and the hydroxy-phenoxyether polymer may be directly achieved. However, it may be desirable to improve adhesion, for example, by pretreating the substrate or by using an additional component to form or improve the bond between the hydroxy-phenoxyether polymer and the substrate. Pretreating typically involves exposure of or addition to the substrate of a material capable of altering the surface characteristics of the substrates. For example, when laminating a hydroxy-phenoxyether polymer film to a paper substrate, superior adhesion is observed for paper that has been impregnated with hydroxy-phenoxyether polymer than is observed for paper that has not been impregnated with the polymer

For selected substrates, pretreating materials may include starch in ether or ester form, cellulose ether, ethylene acrylic acid, polyacrylamide, or mannogalactan gum. A primer, tie coat, or other substance may also be applied to the substrate to improve adhesion of the hydroxy-phenoxyether polymer to the substrate. For example, satisfactory adhesion between a hydroxy-phenoxyether polymer coating and a nonpolar substrate may be difficult to achieve. In such cases, a suitable tie layer between the nonpolar substrate and the hydroxy-phenoxyether polymer coating may be used, for example, an ethylene acrylic acid copolymer such as PRIMACOR® available from the Dow Chemical Company.

In the case of fibers, particularly cellulosic fibers, there are several factors that influence the adhesion between the cellulosic material and polymer. These include: wetting of the surfaces; solidification (to provide resistance to shear); deformability (to reduce stress concentration); intimate contact between surfaces (such as is preferred for chemical bonding); diffusion of macromolecules of bonding materials within the adhesive zone; temperature (adhesion increases near T_{g}, and lowering T_{g}'s, for example, by adding water, may increase adhesion within the composite). Adhesion may also be influenced by the capability of the polymer molecules to penetrate into the cracks and pores of the cellulosic material. The effective diameter of the polymer may also affect its penetration ability.

Adhesion or bonding may be improved by improving the surface reactivity of the fiber. Preferably, this may be done by chemical or electrochemical means. For example, one may increase the ionic character of the cellulosic material. Ionic bonding with the cellulosic material may be helpful because ionic bonds are rapidly formed in aqueous systems and need no further curing, and compounds capable of forming ionic bonds are often soluble in water, the preferred solvent for the solutions and dispersions herein. Furthermore, ionic bonds are usually reversible, and these electrostatic attractions may take place over a greater distance than covalent bonds.

Reactive products known in the art may be used to create anionic sites on the cellulosic material. Polyethylene amine, polyaluminum chloride, cationic, anionic, or amphoteric polyacrylamides, cationic or amphoteric starches, microparticulate silica, zeolites, and cationic guar or galactomannan gum are examples of preferred materials used to control electrokinetics in papermaking. Polyacrylamide resins are the most commonly used synthetic dry strength resins, and the most widely used dry strength aid is modified starch, typically in cationic form, although in certain applications the amphoteric form may be preferred. Cellulose fibers in water have a preexisting anionic charge, therefore, when anionic additives are used, there is a need to address the cationic demand of the system to get good retention. This is typically accomplished through the addition of alum or a cationic polymer to the system.

Additionally, other methods may be used, such as treatment with wetting agents, surfactants, and acids or bases. Polymers having good wetting capability towards the cellulosic material may, during the drying process, enhance strength as the polymer comes into closer contact with the cellulosic material. Other factors that may influence bonding are the particle size, viscosity, stabilizer level, and presence of functional groups like carboxyl groups within the polymer or on the surface of the cellulosic material. Carboxyl groups like ethylacrylate may increase tensile strength and elongation by almost two-fold. Surfactants may improve bonding by helping to reduce surface tension or increase the hydrophobicity of the cellulosic material. This in turn allows the building of a bulkier web at a given level of water. POLYWET™ surfactants (available from Peach State Labs of Rome, Ga.) may be used to improve stability and adhesion.

In addition to aiding bonding or adhesion between fibers, the chemical and electrochemical methods discussed above are useful in helping to make a more homogeneous distribution of polymer resin in the fibers as may be desired in some preferred embodiments. Homogeneity is also facilitated by physical methods including mixing, beating, and exerting pressure on the composite.

The substrates of preferred embodiments are typically in the form of webs or sheets of fibers, however, substrates in other physical forms may also be coated by the methods of the preferred embodiments. Other suitable substrate forms include, but are not limited to, solid sheets, such as, for example, glass, metal, or polymer sheets, fabrics of woven fibers, foamed materials, loose fibers, shaped materials, wood and wood laminates, particleboard, medium density fiberboard, and other lignocellulosic materials, either natural or synthetic, and honeycomb-like structures (e.g., cellular structures having open or closed cells of one or more shapes, including without limitation hexagonal, polygonal, and/or rounded shapes).

One method for forming shaped materials involves pulp molding, commonly used to form shaped objects from cellulosic materials. In one type of pulp molding, known as dip molding, a wire mould is formed into the shape of the object in question, for example, an egg carton. The mold unit is attached to a vacuum source with an intermediate separator or trap, such that when the mold is dipped into a pulp slurry, water is drawn through the wire and deposits a paper web on the surface of the wire in the shape of the object. When sufficient thickness of cellulosic material is built up on or in the mold, the mold is withdrawn from the pulp slurry and air may then be drawn through the wet web to partially dry it. The formed shape is then transferred to a support and dried by, for example, passage through an oven, infrared drying unit or similar drying system to produce the final article. In some instances, for example, the production of smooth, glazed containers, the wet article may be inserted into a polished die and expanded against the heated walls of the die by an inflatable rubber bladder. The bladder may then be deflated and the shape removed from the die for final drying.

More preferably, the substrate is paper. Paper may be formed by any method well known in the art, as described in Assignee's copending application entitled HYDROXY-PHENOXYETHER POLYMERS IN PAPERMAKING, application Ser. No.______ [Attorney Docket No. APTLTD.018A], filed on the same date as the present application, the entirety of which is hereby incorporated by reference. Such paper may optionally be subjected to sizing. The term ‘sizing’, as used herein, is a broad term and is used in its ordinary sense, including, without limitation, resistance to penetration by a liquid. For a particular liquid, sizing may be assessed qualitatively by observing the extent and rate at which a drop of liquid spreads through the paper after being placed on the surface of the paper, for example, by measuring the rate of spreading as a function of time.

Various types of water, grease and aqueous liquids may be used to assess sizing, depending on the intended application for the paper. For instance, in a packaging application involving a greasy or oily food, the use of the grease or oil in question may be appropriate, whereas orange juice, milk or water may be more appropriate test fluids in situations where resistance to those liquids is desirable. In other situations a more quantitative measure, such as a measurement of Cobb sizing, is appropriate.

The Cobb test evaluates sizing in terms of the amount of liquid absorbed by the paper over a defined interval of time and is typically reported as the weight of liquid absorbed in units of grams of liquid per square meter of paper. It is a well-defined method known to those skilled in the art (see, for example, the Technical Association of the Pulp and Paper Industry (TAPPI) test method TAPPI T 441 om-90 (1990)). The lower the Cobb value, the better the sizing, and a decrease in Cobb value represents an increase in sizing. Other tests may be used to assess sizing, for example, the Hercules Sizing Test (HST) T530 pm-89, a size test for paper by ink resistance.

Test methods used for oil and grease resistance include the 3M Kit Test and the TAPPI Test Method T 454 om-89. The 3M Test Kit is identical to the TAPPI Useful Method 557. It consists of testing the paper with droplets of increasingly aggressive mixtures of castor oil, toluene, and heptane to determine resistance to staining. Higher Kit numbers indicate better oil and grease resistance. The TAPPI Test Method T 454 om-89 is a turpentine test for grease resistance of paper. It involves exposing a sheet surface to sand saturated with colored turpentine for different periods of time. Longer exposure times without staining indicate better grease resistance.

Coatings

The term ‘coating,’ as used herein, is a broad term and is used in its ordinary sense, including, without limitation, the process of formation of a layer or coat of hydroxy-phenoxyether polymer, either pure or mixed with one or more additional components, onto a substrate. Planar coating is used for flat films and sheets, and contour coating for general three-dimensional objects. Hydroxy-phenoxyether polymer having a very high gas harrier property may be used both for planar and contour coating of plastics, wood, textiles, paper, and the like. The high natural adhesion of hydroxy-phenoxyether polymer coating allows it to exclude many chemical pre-treatment materials, such as primers, on its surfaces. An example of an environmentally friendly method of coating is thermal spray coating, which involves a spraying of solid polymer particles in a jet of very hot gases, which results in their rapid fusion before reaching the substrate.

Plastisol Coating Methods

By preparing a plastisol of hydroxy-phenoxyether polymer, a coating may be applied to substrates using methods typically used for wet coating. The term “plastisol”, as defined herein, is a broad term and is used in its ordinary sense, including, without limitation, a dispersion of hydroxy-phenoxyether polymer particles suspended in a liquid organic substance, such as a plasticizer or solvent, that gels and then fuses when processed by heat. Plastisols are advantageously used when application of a high concentration of polymer is desired, for example, greater than about 30 wt. % polymer or the upper limit of polymer that may be dissolved or dispersed in a solvent. However, elevated temperature is required to get the plastisol into liquid form. Depending upon the application, it may be preferred to use a solution or dispersion of hydroxy-phenoxyether polymer, wherein the dispersion or solution is a liquid at room temperature, rather than a plastisol in the coating methods described herein.

In a preferred embodiment, the process for coating a substrate involves providing a substrate and a plastisol of a hydroxy-phenoxyether polymer, then applying the plastisol in liquid form to at least a portion of the substrate to form a coating, after which the solvent is evaporated from the plastisol or the plastisol is cooled, thereby yielding a coated substrate. The plastisol may be applied using any convenient technique. Evaporating may be accomplished by simple evaporative techniques, or may be encouraged by known methods such as by heating. Cooling may be accomplished by refrigeration or exposure to ambient lower temperature conditions.

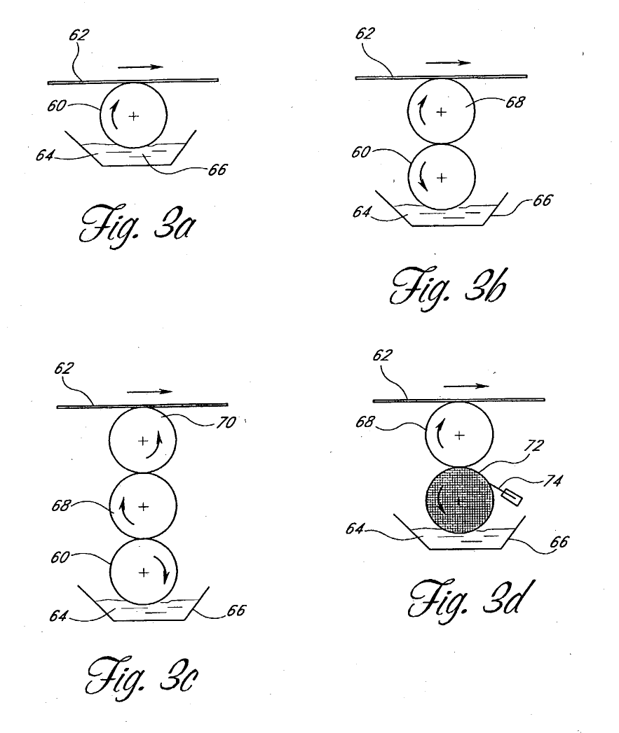

Substrates in sheet form may be coated using a plastisol, solution, or dispersion using a variety of known methods, including: roll, reverse roll, gravure, dip saturation, fountain, blade, rod, and air knife. FIGS. 3a-d illustrate schematics of four preferred embodiments of roll coaters. The simplest form of roll coater, illustrated in the schematic of FIG. 3a is a roll 60 in contact with a substrate 62, the roll 60 dipping into a liquid 64 contained in a pan 66. This type of system is very sensitive to changes of speed and the level of the liquid 64 in the pan 66. The addition of a transfer roll 68, as illustrated in the transfer roll coater of the schematic of FIG. 3b, smoothes out the liquid film on the lower roll 60 and presents a more uniform coating to the substrate 62. Changing the gap between the rollers 60, 68 controls the thickness of the liquid film transferred to the sheet 62. The liquid film may be sheared down further by using a reverse-roll applicator, as illustrated in FIG. 3c, in which the direction of rotation of the transfer roll 68 is opposed to the direction of travel of the paper or board substrate 62, which is in contact with the applicator roll 70. Coat weights between 5 and 20 g/m² per side are typically preferred.

A gravure coater is illustrated in the schematic of FIG. 3d. For gravure coating the engraved cells on the surface of the gravure roll 72 pick up the solution or dispersion 64, with the excess being doctored off by a blade 74. This enables the gravure roll 72 to apply a precise coating thickness regardless of variations in the substrate thickness typically laying down coat weights of between 0.5 and 8 g/m². The coating solution or dispersion is preferably of a fairly low viscosity.

In rod coating, the excess liquid is removed by either a smooth or a wire wound rotating rod (Mayer bar). The amount of coating applied is governed by wrap around the applicator roll, wire diameter around the rod, web tension and coating solution or dispersion viscosity and solids. Rod coaters may typically be operated at solids levels of about 62% or less and speeds of 5,500 ft/min or less.

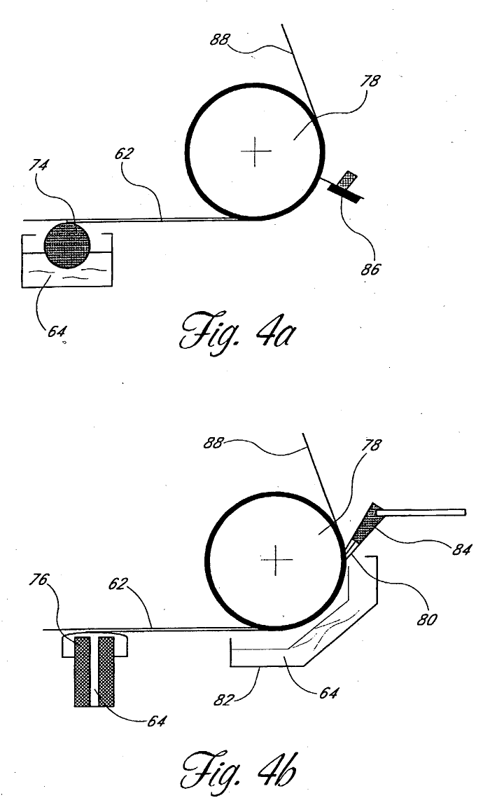

FIG. 4 provides schematic diagrams of a preferred blade coater (FIG. 4a) and a preferred air knife coater (FIG. 4b). Air knife, blade and rod coaters use either a roll coater 74 or a fountain applicator 76 to apply the initial layer of coating, then employ a separate metering method for control of coatweight of the coated sheet 88. A backing roll 78 supports the substrate. The fountain applicator 76 is a slit or channel through which the dispersion or solution 64 is forced in order to ply upon and be picked up by the passing sheet surface 62.

In air knife coating the liquid 64 is applied in excess to the substrate 52, then an air curtain 80 is used to remove the excess liquid 64, which is collected in a catch tray 82, as well as to level the coating on the sheet 52. The amount of coating applied is governed by air pressure, angle of the air jet 84, machine speed and resin solids. Air knife coaters may typically be operated at solids levels of about 52% or less and speeds of 2,500 ft/min or less.

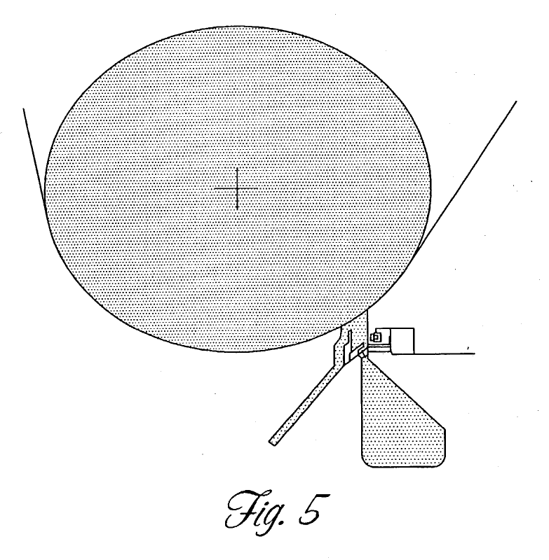

In blade coating, a flexible steel blade 86 acts as the metering device. The coatweight of the coated sheet 88 then depends on blade angle and pressure, solution or dispersion solids, machine speed as well as substrate roughness compressibility and permeability. In a preferred embodiment, the coating may be applied with a short dwell coater as illustrated in the schematic of FIG. 5. The short dwell coater utilizes a backing roll 78, a coating supply 64, and a blade 86. Blade coaters may operate at higher solids levels and therefore require less drying energy than rod or air-knife coaters. They may also be operated at higher speeds and greater output. The polymer film produced by blade coating is of constant level but variable thickness.

The substrate is typically supported by a backing roll at the point of contact with the transfer roll. The transfer, reverse roll and gravure coaters usually pre-meter the liquid before application. In the case of blade, air knife and rod coaters, the metering process usually takes place after application.

The aforementioned contour coating methods, including air-knife or metering bar (‘rod’) coaters, all involve application of a coating which follows the surface profile of the sheet and has a nearly constant thickness. In such methods, the improvement of film integrity may require thickening agents or rheology modifiers to improve the coverage and uniformity of the coating. The performance of the hydroxy-phenoxyether polymer in barrier coating may be improved by the addition of platy clays to the material, at a level below the critical pigment volume concentration, to improve barrier properties. After coating, the sheets may be calendered to improve surface smoothness.

Non-Aqueous Coating Methods

In applications where it is not advantageous to apply the heat necessary to liquefy the hydroxy-phenoxyether polymer or a plastisol thereof, or where it is not advantageous to use any of the above-mentioned coating methods, the polymer may be applied to a substrate in the form of a non-aqueous solution or dispersion using wet coating methods. Wet coating methods may also be used with aqueous solutions of hydroxy-phenoxyether polymer, as disclosed in Assignee's copending application entitled HYDROXY-PHENOXYETHER POLYMERS IN PAPERMAKING, application Ser. No.______ [Attorney Docket No. APTLTD.018A].

One method of applying the solution or dispersion to a substrate includes spraying the non-aqueous solution or dispersion through fine nozzles on a spray beam or using an air-jet sprayer as in paint application. This method limits solids content and requires high levels of filtering, but is appropriate for spraying the solution or dispersion between the plies of a multi-ply sheet as in paperboard production.

Foam addition is another suitable method. A foam generator and applicator system may be used, along with a foam builder. Low density molded fiber foam or fiber foam sheets may be prepared through the use of physical blowing agents or chemical blowing agents, including water, solvents, gases, starch, and other foaming or blowing agents such as are known in the art. In preferred embodiments, commercial, environmental friendly Chemical Blowing Agents (CBA) are used, especially in the production of extruded hydroxy-phenoxyether polymer sheets. Use of such CBA's at levels of 5% wt. in the hydroxy-phenoxyether polymer mixture to be extruded generally produce satisfactory closed cell foams with substantially spherical and uniform cellular structure.

Hydroxy-phenoxyether polymer compositions containing a solvent may not foam unless the temperature is sufficient to facilitate foaming and there is room for the foam to expand (i.e. a molded article under pressure may generally not foam until it the pressure is reduced or it is removed, at least partially, from the mold). Generally, the temperature should be high enough such that the solvent has a sufficiently high vapor pressure to support foaming. Also, the thermoplastic may not generally foam if it is at a temperature below its softening point, and may foam most readily with good cell formation when it is near or above its melt temperature. For hydroxy-phenoxyether polymers, the preferred temperature range is about 150°-450° F., more preferably about 350-450° F.

By using hydroxy-phenoxyether polymer in foam form, several advantages may be realized. These advantages include decreased cost and density, improved thermal insulation and electrical insulation, improved cushioning properties, and the like. The commercial fabrication and application of hydroxy-phenoxyether polymer foams is based on general advantages and disadvantages of foams, as well as some specific chemical and physical properties of foamable polymers, such as the hydroxy-phenoxyether polymer. Foaming of polymers may achieve enhancement in certain physical properties when compared to the unfoamed polymer, including reduced weight, improved stiffness or stiffness to weight ratio, increased thermal resistance, improved shock absorption, increased liquid absorption, and improved sound deadening. However, polymers may lose certain physical properties when foamed, including reduced modulus elasticity, reduced elongation at break, reduced toughness, reduced impact strength, reduced creep resistance, increased brittleness, decreased fir resistance, less desirable surface appearance, and decreased solvent resistance.

In the production of any polymer foams, a careful balance needs to be achieved between the foaming gas solubility and its diffusivity in a polymer melt. Many commercially available CBA's generate nitrogen or carbon dioxide, have rather small molecules, and have great solvating power that tends to swell and/or dissolve the polymer. Ideally, a CBA should be moderately soluble in the polymer and should have a relatively low diffusion or permeation rate.

The chemical structure of hydroxy-phenoxyether polymer contributes to its good gas barrier properties in solid state. However, for the same reason, in the melt state, hydroxy-phenoxyether polymer melt also has a very low gas permeability rate, making it possible to easily produce hydroxy-phenoxyether polymer foams in a wide range of densities.

Extrusion techniques may be used for production of hydroxy-phenoxyether polymer foams with substantially uniform or isotropic cellular structure. Hydroxy-phenoxyether polymer foams with non-uniform cellular structure, such as structural foams, may be produced by injection molding techniques.

In a preferred embodiment, the foam may be a filled/foamed composite. These composites include two types of fillers: a solid component such as fibers, powders, flours, and the like, and a gaseous component. These ‘double’ composites are becoming increasingly popular, especially when the binder or matrix is an expensive polymer. Because gas filling provides a foam of low density, and the solid filler is inexpensive, the final cost of the composite substantially decreases. One example of such a filled/foamed composite having a uniformed thickness and width is prepared from a mixture of 90 wt. % hydroxy-phenoxyether polymer containing MFI-20 and 10 wt. % sisal flour, foamed with the CBA PolyCore 263-K (available from American Foam Technologies of Ronceverte, W. Va.).

In the case of sheets or shaped articles, or any other porous material, particularly cellulosic shaped articles, the polymer may be added by impregnation of the sheet or article by dipping the sheet or article into a non-aqueous solution or dispersion with or without the application of pressure or vacuum to the article to force the polymer into the interior of the mass. The sheet or article may then be dried in the usual manner to give a product with superior properties, e.g. improved water and oil resistance, improved toughness, and improved compressive and tensile strength. The quantity of polymer to be combined with the substrate may vary depending upon the surface area of the substrate to be coated, e.g., small particles or fibers versus larger particles or fibers. Typically, when a substrate comprising cellulosic fibers is impregnated with the hydroxy-phenoxyether polymer, the polymer may comprise up to 99 vol. % or more of the impregnated substrate, preferably up to about 50 vol. % of the impregnated substrate, more preferably from about 10 vol. % to about 50 vol. % of the impregnated substrate. For certain substrates, lower or higher volume percents may be suitable. Suitable fibrous-based materials include, but are not limited to, plant fibers made from wood pulp, cotton fibers, hemp, bagasse, abaca, flax, southern pine, southern hardwood fibers, cellulose, wheat, starch, modified starch, chitin, chitosan, keratin, cellulose acetate, cellulose materials derived from agricultural products, gluten, nut shell flour, wood flour, corn cob flour, guar gum, and mixtures thereof. Additional fibers may also be added to reinforce the structure, such as hydroxy-phenoxyether polymer as a monofilament or bicomponent fiber with a core made from a polyolefin, such as polypropylene.

The impregnated articles of preferred embodiments may be substantially impermeable to oils and/or greases, or may be substantially impermeable to gases such as oxygen and carbon dioxide, thus providing increased shelf life to perishable goods packaged using such laminates. In a preferred embodiment in packaged goods applications, the impregnated article contains an oxygen scavenger component to assist in the removal of oxygen from the packaged goods. Suitable oxygen scavengers include, but are not limited to those wherein the oxygen scavenger component is activated or triggered by light or other types of electromagnetic radiation.

In preferred embodiments, the impregnated articles of the present invention are fabricated using mass production methods. The impregnated articles of preferred embodiments may be fabricated into any suitable form, such as, for example, containers. Such containers may preferably have a liner composed of polyethylene terephthalate (PET) resins. In a particularly preferred embodiment, such a PET liner is stretch blow-molded into the impregnated article's structure. The shape of the impregnated article may vary depending upon the application, but may include, for example, tubular shapes. Certain impregnated articles may be thermoformed into a functional shape for protective packaging, for example, a form suitable for protection from water saturation, or bubble pack form used for cushion packaging. Preferably, the impregnated article is fully recyclable or repulpable, or the polymer may be recovered from the laminate structure for reuse in similar or alternative applications.

Such impregnated articles may be further coated, for example, with hydroxy-phenoxyether polymer, or fashioned into laminates according to the methods described herein or any other suitable method.

In other preferred embodiments, the coating may be applied, for example, by spraying a polymer solution or dispersion onto one or more sides of a substrate, by applying a coating of dispersion or solution on one or more sides using a blade coater; by coating or impregnating by placing the dispersion or solution onto one or more sides of the paper or web and allowing gravity, pressure, or vacuum to draw the substrate to the polymer; and the use of size pressing technology, such as is known in the art, to coat a substrate with a non-aqueous dispersion or solution of polymer.

Dry Coating Methods

In preferred embodiments, the substrate may be coated by the hydroxy-phenoxyether polymer by any suitable dry coating method. Nonlimiting examples of suitable methods include powder coating, hot calendar coating, extrusion coating, and cast coating.

In powder coating methods, powdered resin is applied directly to the substrate. Powder coating is a desirable pollution-free and resource-saving method, since it may be used to form a coating film without using an aqueous or an organic solvent. The powder may be applied to the substrate by a variety of methods, including, for example, electrostatic methods, sifting methods, and rotational molding methods.

The electrostatic powder coating method comprises charging a powder coating by a corona charge method or a frictional electrification method, spraying said powder coating on an earthed coating object to allow electrostatic adhesion of the powder coating. In the sifting method, powder is applied to the substrate by a rotating brush roll operating above a screen surface.

After the powder is applied to the substrate, then the hydroxy-phenoxyether polymer is melted to form a coating film. One method for heating the polymer is to pass the substrate coated with powder under an infrared heating zone. Upon application of heat, the polymer melts, thereby fusing it to the substrate.

In rotational molding, or ‘rotomolding’, polymer powders are heated in rotating metal molds where a hollow item to be coated is placed. The hollow item may be a polymer, mineral, metal, ceramic, glass, or the like. During rotation and heating, the polymer powder coats the internal surface of the hollow item and produces a thin polymer film on it. Conventional rotomolding apparatus commercially available may be used without modification to apply hydroxy-phenoxyether polymer to various hollow items. Hydroxy-phenoxyether polymers are particularly well suited for use in rotomolding technology because of the high adhesion of the polymer to the surface to be coated in the melt stage, and because of its high barrier properties in the solid state when placed in coating form on the internal surface of hollow items. Rotomolded products may include containers for potable water, fuel oil, corrosive liquids, fertilizers, and the like. Rotomolding techniques may also be used to coat flat-sided products, for example, pallets, cable reels, frames, shells, and the like.

In a hot calendar coating process, a heated plastic mass of hydroxy-phenoxyether polymer is formed into a sheet or film which is then pressed against the substrate to be coated. The roll pressure at the point of application may be varied to control the degree of penetration of the coating into the substrate. Such coatings are typically applied in thicknesses of from about 0.025 mm to about 1 mm, however, thinner or thicker coatings may be applied by this method.

In extrusion coating, a sheet of hydroxy-phenoxyether polymer formed by extrusion through a slot die is pressed against the substrate, which is also in sheet form. The extrusion die slot opening is usually set to less than about 0.5 mm. Thinner films may be obtained by draw down or thinning the extruded film by operating the coating nip at a suitable rate of speed. The hydroxy-phenoxyether polymer may be extruded directly onto one or both sides of the substrate. The hydroxy-phenoxyether polymer may be extruded alone, or it may be coextruded with another thermoplastic material, such as a polyester, onto the substrate. Hydroxy-phenoxyether polymer exhibits good processability and steady speed process within the melting temperature range. Such extruded films demonstrate substantially uniform thickness and with, without substantial visible surface defects, such as bubbles, caverns, and the like. When hydroxy-phenoxyether polymer granules to be extruded are been mixed with small amounts of dark pigment in the form of solid powder, paintable, pigmented extruded sheets having very uniform color and excellent surface quality may be produced.

An interesting feature of such extruded hydroxy-phenoxyether polymer is the ability to achieve partial orientation. When the conveyer speed in an extrusion unit is increased up to about 10-20% above its optimal speed, the hydroxy-phenoxyether polymer sheets on the belt surface exhibit a decrease in width and visible orientation. The hydroxy-phenoxyether polymer sheets maintain their integrity and do not suffer any mechanical degradation. Conversely, when the conveyer speed is decreased back to optimal speed, the thickness of the film increases and the orientation effect disappears.

Orientation may have significant effects on the barrier properties of the hydroxy-phenoxyether polymer film. It is well known in the art that mechanical orientation of polymers generally decreases their gas permeability, resulting in an improvement of the polymers' gas-barrier properties. Mechanical orientation of hydroxy-phenoxyether polymer films is therefore a method for further decreasing the transmission rate of hydroxy-phenoxyether polymer films to oxygen, carbon dioxide, and other atmospheric gases and moisture, and for further improving protective packaging properties of materials containing these films.

Such extruded coatings may include only hydroxy-phenoxyether polymer, or hydroxy-phenoxyether polymer in combination with other components, such as, for example, fibrous materials including, but not limited to, plant fibers made from wood pulp, cotton fibers, hemp, bagasse, abaca, flax, southern pine, southern hardwood fibers, cellulose, wheat, starch, modified starch, chitin, chitosan, keratin, cellulose acetate, cellulose materials derived from agricultural products, gluten, nut shell flour, wood flour, corn cob flour, guar gum, and mixtures thereof. Virtually any other solid material in particulate or fibrous form may also be included with the hydroxy-phenoxyether polymer, including, for example, particles or fibers of metal, wood, plastic or polymer, glass, stone, concrete, ceramic, and mixtures thereof.

A further method of application is cast-coating in which a layer of polymer is coated onto a smooth, heated cylinder then transferred in a semi-dry state to the surface of the substrate. Such methods are commonly used when a very smooth, glossy surface is applied but operate at slower speeds than blade coating. Short-dwell coaters combine the application and metering stages in one unit.

Another dry method of applying hydroxy-phenoxyether polymer to a porous substrate is dry impregnation. In dry impregnation, fine hydroxy-phenoxyether polymer powders are impregnated into the surface of porous substances, such as wood, concrete, ceramic, metals, and the like. The method generally uses ultra-sonic vibration to insert small polymer particles into the open pores of the substrate. The surface layers containing solid polymer particles are then heated up above the melting point of polymer, resulting in a thin surface solid polymer layer that covers the surface of material.

Dry coating methods are advantageously used for substrates that are water sensitive or water repellant, or in situations where the drying time for water removal is limited by virtue of the configuration of the process or the speed of operation. For example, in the coating of cellulose fibers for masterbatch production of thermoforming materials or the production of laminated security products, dry coating methods may be preferred.

Other processes to prepare composites of hydroxy-phenoxyether polymers and fibers are disclosed in Assignee's copending application entitled HYDROXY-PHENOXYETHER POLYMER/FIBER COMPOSITES, application Ser. No.______ [Attorney Docket No. APTLTD.020A], filed on the same date as the present application, the entirety of which is hereby incorporated by reference.

Laminates

Coating methods may be used to apply dispersions of hydroxy-phenoxyether polymer to the surface of a substrate, for example, paper or board, for the purpose of laminating it to another sheet. Extrusion coating methods may also be used to apply hydroxy-phenoxyether polymer to substrates to be laminated to another sheet. Sheets of several layers may be built up to provide feedstock for folding cartons, liquid packaging, and pouches. The hydroxy-phenoxyether polymer may be a pre-formed film comprising one of the layers of the laminate, or may be applied between the layers as a foam composition instead of by a coating process. The individual sheets or plies of the laminate may themselves contain a hydroxy-phenoxyether polymer or may be pre-treated with hydroxy-phenoxyether polymer by any of the methods outlined above or any other suitable method. In this way a multi-ply composite structure may be built up with a high polymer content, suitable for thermoplastic forming, such as for trays and inserts. Interlayer-addition of hydroxy-phenoxyether polymer by coating or foam application may also be used in the production of spirally wound paper tubes, cores and containers. The hydroxy-phenoxyether polymer acts as both inter-layer adhesive and reinforcing agent to improve strength and rigidity.

Lamination methods are well known in the art as means of forming a composite from multiple layers of materials. In preferred embodiments, both cold lamination and hot lamination techniques may be used to produce laminates comprising hydroxy-phenoxyether polymer. In the case of cold lamination methods, however, a suitable pressure sensitive adhesive or adhesive capable of curing at room temperature is used in addition to the hydroxy-phenoxyether polymer and the substrate, unless the substrate itself possesses suitable adhesive properties. In the case of hot lamination methods, heat may be used to form a bond between the hydroxy-phenoxyether polymer and the substrate directly (by melting or partially melting the hydroxy-phenoxyether polymer), or else an additional low melting material may be provided to bond the hydroxy-phenoxyether polymer layer to a substrate layer upon application of a sufficiently high temperature. In a lamination method of a preferred embodiment, a hydroxy-phenoxyether polymer film is thermally fused onto a surface of a substrate, such as paper, to be laminated. There may be some overlap between lamination processes and certain of the dry coating methods described above, particularly extrusion coating methods.

The term ‘laminate’, as used herein, is a broad term and is used in its ordinary sense, including, without limitation, layered structures formed from a layer of substrate, for example, paper, and a hydroxy-phenoxyether polymer. An additional layer, for example, a second substrate, may also be present in the laminate, forming a sandwich with the hydroxy-phenoxyether polymer in the middle. Other additional layers may also be present. Suitable substrates include virtually any solid material, and may contain components such as, for example, paper, metal, wood, plastic, glass, stone, concrete, ceramic, metallic foils, textile fabrics, paperboard, foam, sheets that form bonds at increased temperature, inorganically-filled sheet, polymer, fibrous-based material and mixtures or derivatives thereof. Suitable fibrous-based materials include, but are not limited to, plant fibers made from wood pulp, cotton fibers, hemp, bagasse, abaca, flax, southern pine, southern hardwood fibers, cellulose, wheat, starch, modified starch, chitin, chitosan, keratin, cellulose acetate, cellulose materials derived from agricultural products, gluten, nut shell flour, wood flour, corn cob flour, guar gum, and mixtures thereof. Additional fibers may also be added to reinforce the structure, such as hydroxy-phenoxyether polymer as a monofilament or bicomponent fiber with a core made from a polyolefin, such as polypropylene.

The hydroxy-phenoxyether polymer may be a separate layer and/or may be contained within one or more of the substrate layers, and generally serves to bond one or more of the layers to one another, although other substances may be used as the bonding agent instead of the hydroxy-phenoxyether polymer. The laminate may include a layer of hydroxy-phenoxyether polymer and at least one other layer. The additional layer may also include a hydroxy-phenoxyether polymer, or may be a chemically different layer. In a preferred embodiment, one layer is a hydroxy-phenoxyether phenoxyether polymer and the other layer is paper. Such a laminate may also include at least one additional layer comprised of a second paper or a solid non-paper material.

In the laminates described herein, the amount of hydroxy-phenoxyether polymer in the laminate may vary depending upon the application. However, the laminate may preferably include one sheet containing from about from about 0.25 wt. % to about 75 wt. % hydroxy-phenoxyether polymer with the remainder including a fibrous material, and more preferably may include one sheet containing from about from about 0.5 wt. % to about 50 wt. % hydroxy-phenoxyether polymer with the remainder including a fibrous material. Such a sheet may create a barrier to fluid within the laminate structure. In preferred embodiments, such a sheet includes finely dispersed air voids.

The laminates of preferred embodiments may be substantially impermeable to oils and/or greases, or may be substantially impermeable to gases such as oxygen and carbon dioxide, thus providing increased shelf life to perishable goods packaged using such laminates. In a preferred embodiment in packaged goods applications, the laminate contains an oxygen scavenger component to assist in the removal of oxygen from the packaged goods. Suitable oxygen scavengers include, but are not limited to those wherein the oxygen scavenger component is activated or triggered by light or other types of electromagnetic radiation.

The overall percentage of hydroxy-phenoxyether polymer in the laminate may vary depending upon the application, but typically may range from about 1 wt. % to about 50 or 60 wt. % of the total solids weight of the laminate, preferably from about 2 wt. % to about 30 or 40 wt. % of the total solids weight of the laminate, more preferably from about 5 wt. % to about 15 or 20 wt. % of the total solids weight of the laminate, and most preferably from about 7 wt. % to about 10 wt. % of the total solids weight of the laminate.

In general, the process for forming the laminates of the preferred embodiments proceeds by pressing together one or more of the solid materials in such a way as to allow the hydroxy-phenoxyether polymer to at least partially bond the layers together to form a laminate. In preferred embodiments, the laminates of the present invention are fabricated using mass production methods. The laminates of preferred embodiments may be fabricated into any suitable form, for example, containers. Such containers may preferably have a liner composed of polyethylene terephthalate (PET) resins. In a particularly preferred embodiment, such a PET liner is stretch blow-molded into the laminate structure. The shape of the laminate structure may vary depending upon the application, but may include, for example, tubular shapes. Certain laminates may be thermoformed into a functional shape for protective packaging, for example, a form suitable for protection from water saturation, or bubble pack form used for cushion packaging. Preferably, the laminate structure is fully recyclable or repulpable, or the polymer may be recovered from the laminate structure for reuse in similar or alternative applications.

When one of the layers of the laminate is paper, the lamination process preferably involves bringing paper into contact with a solid substrate in the presence of a nonaqueous solution or dispersion comprised of a hydroxy-phenoxyether polymer to form a wet laminate, followed by drying. The paper may be a wet paper or a coated paper as described herein. If the paper is already wet with the nonaqueous solution or dispersion comprised of a hydroxy-phenoxyether polymer, then further amounts of polymer solution or dispersion may be used but are not required. More preferably, the process comprises forming a wet laminate by bringing the wet paper into contact with a solid material, and then drying said wet laminate to form a laminate, optionally with pressure to create a better bond between the layers. Even more preferably, the process comprises forming a wet laminate by bringing a coated paper into contact with a nonaqueous solution or dispersion comprised of a hydroxy-phenoxyether polymer, and optionally into further contact with another paper or non-paper material, then drying the wet laminate to form a laminate, optionally with pressure to create a better bond between the layers. Pressure is preferably applied by running the laminate between rollers. Multiple layers may be formed by repeating the process and/or by bringing together multiple layers simultaneously.

A typical lamination apparatus, such as those manufactured by Ledco, Inc. of Hemlock, N.Y., used in hot lamination includes a roll of the substrate sheet to be coated and a roll of a hydroxy-phenoxyether polymer film. If the hydroxy-phenoxyether polymer is in other than sheet form, for example, a powder or solution, then a suitable apparatus for applying the polymer to the substrate prior to application of heat is provided. Such an apparatus may include a solution reservoir and spray heads for a solution of hydroxy-phenoxyether polymer, or a sifting or powder spray device in the case of hydroxy-phenoxyether powder. The lamination apparatus also includes a heat shoe over which the substrate and any additional layers are passed, the heat shoe applying heat to the layers so as to form a thermal bond between at least two adjacent layers of the laminate. Drive rollers pull the layers over the heat shoe.

The conditions under which the lamination is carried out depend on the properties of the layers to be laminated, any surface treatments or coatings already applied to the substrate, and the thermal properties of the hydroxy-phenoxyether polymer. Temperature, pressure, and tension of the layers in the lamination apparatus are adjusted to suit the components of the laminate. In a preferred embodiment, the laminate comprises a hydroxy-phenoxyether polymer layer bonded to a lower melting component. Some examples of lower melting components include polyvinylidene difluoride which has a melting point of 170° C. and polyethylene, which has a melting point of 120° C.

In another preferred embodiment, the laminate comprises a non-melting or high melting point substrate, for example, cellulosic paper, bonded to hydroxy-phenoxyether polymer which acts as a hot melt adhesive. The term ‘hot melt adhesive’, as used herein, is a broad term and is used in its ordinary sense, including, without limitation, solvent-free thermoplastic materials that are solid at room temperature and are applied in molten form to a surface to which they adhere when cooled to a temperature below their melting points. The hydroxy-phenoxyether polymer when used as a hot melt adhesive may be in the form of a web, a matted fibrous material, a woven material, or a powder prior to application of heat to melt the polymer and form the bond with the substrate. Preferably, a hydroxy-phenoxyether polymer available from Dow Chemical of Midland, Mich. under the tradename BLOX 0005 is used as a hot melt adhesive in cellulosic paper laminates. This hydroxy-phenoxyether polymer exhibits a melting point of 190° C. Other hydroxy-phenoxyether polymers may be suitable for use as hot melt adhesives in other applications, provided that the hydroxy-phenoxyether polymer exhibits a lower melting point than at least one other layer of the laminate. For example, hydroxy-phenoxyether polymer may be used as a hot melt adhesive with a polyethylene terephthalate sheet, the polyethylene terephthalate having a melting point of 249° C., substantially higher than the 190° C. melting point of hydroxy-phenoxyether polymer.

In preferred embodiments, the hydroxy-phenoxyether polymer hot melt adhesive is bonded directly to the substrate without any special preparation of the substrate. In some embodiments, however it may be preferable to form a bond between the hydroxy-phenoxyether polymer hot melt adhesive and a substrate while the substrate is wet, for example, with water or a non-aqueous liquid, as describe above. When the substrate is cellulosic paper, an advantage to performing such a lamination is that a separate drying step between formation of the paper from a fiber slurry and lamination is not required.

Alternatively, the substrate may be treated with a substance that may enhance the bond between the hydroxy-phenoxyether polymer and the substrate. Such treating substances are described above for cellulosic fibers and nonpolar polymers. Another method of improving adhesion involves oxidation of the substrate surface, for example, by direct flame impingement or corona discharge. Such methods are commonly used in the aqueous coating of polyolefin films.

In a further embodiment of the present invention, the hydroxy-phenoxyether polymer is applied to the substrate in solution or dispersion form, then the substrate is subjected to elevated temperature to drive out the solvent and melt the hydroxy-phenoxyether polymer. In a preferred embodiment, the hydroxy-phenoxyether polymer is applied in solution or dispersion form to a first substrate, and then another layer of the same or a different substrate is placed atop the first substrate. The substrate should be nonsoluble or minimally soluble in the solvent used to prepare the solution or dispersion of hydroxy-phenoxyether polymer. Heat is then applied to the layers, resulting in a laminate comprising the two substrates bonded together by a hydroxy-phenoxyether polymer layer. In a particularly preferred embodiment, the substrates are cellulosic papers.

Hot melt lamination methods may be preferred methods for use in the converting industry, but for paper or paperboard production such methods are typically less preferred. Converting includes the processes or operations applied to paper or paperboard after the normal base sheet has been produced on a paper machine. For example, various consumer products such as bags, boxes, pouches, and envelopes require converting operations to convert a base sheet to a useable consumer product. Embossing, sheeting, supercalendering, and off-line coating are typical converting operations. Some converting operations are in-line on the paper machine, and as such are considered to be an integral part of the papermaking operation. Hot melt coating is not done on paper machines, but converting operations may include hot melt coating, which is typically done at lower speeds in converting plants.

The preferred method for production of laminated structures comprising hydroxy-phenoxyether is coextrusion. In coextrusion, a laminated structure is formed by the simultaneous extrusion of two or more polymers through a single die where the polymers are joined together such that they form distinct, well-bonded layers. Single extrusion products such as films, sheets, wire coating, profiles, and the like may be prepared in this way. For example, a well-known commercial coextrusion process known as ‘Solid polystyrene/Foamed polystyrene/Solid polystyrene’ is used to produce egg-cartons and meat trays. The same coextrusion process may be used for production of multi layered hydroxy-phenoxyether polymer solid unfoamed multi-layer films and sheets.

In a preferred embodiment, hydroxy-phenoxyether polymer containing laminates further comprise a foam. The foam may or may not contain hydroxy-phenoxyether polymer. For example, a foam comprised of hydroxy phenoxyether polymer may be ‘sandwiched’ between two or more layers, for example, paper sheets, to produce a laminated structure. In the case of paper sheet, impregnation of a pre-dried sheet with the hydroxy-phenoxyether polymer makes more efficient use of the natural bonding properties of the cellulosic material in the lamination process and permits some control of the distribution of polymer through the thickness of the sheet. This may be done by applying a nonaqueous solution or dispersion of the polymer to the paper sheet prior to lamination.

Alternatively, the foamed internal layer is formed from commodity plastics and the external sheets are made from solid hydroxy-phenoxyether polymer film. In such laminates, the high barrier properties of hydroxy-phenoxyether polymer are exploited while the middle foamed zone decreases the cost and the density of the final product. Such hydroxy-phenoxyether polymer films may be particularly well suited for use as barrier films to minimize the thermal aging of insulation foam based on polystyrene, polyethylene, polypropylene, polyvinylchloride, and polyurethane. Such foams are typically encapsulated in barrier films, which serve to prevent the insulation gas from diffusing from the foam. At the same time, the barrier films prevent diffusion of air, oxygen and nitrogen into the insulation foam, which is important for open cell foams.

The barrier films used in conventional insulating foams are typically made of aluminum foil, coated paper, or polyvinylidene chloride (PVDC). These barrier films are adhered to the foam substrate with an adhesive tie layer of ionomer resins and certain polyolefins, such as ethylene vinyl acetate or polyethylene films. Typically, the barrier films are coated with the tie layer first, then hot laminated to the extruded foam board. This technology is very complex, time and energy consuming, and is not environmentally friendly.

In using hydroxy-phenoxyether polymer films as barrier films, thermal spray coating or dry impregnation techniques are preferred for applying the barrier film to the insulating foam.

Sheets of several layers may be built up by lamination to provide feedstock for folding cartons, liquid packaging and pouches. Plastic pouches are a low cost pack for liquid milk, estimated to be 75% cheaper than an equivalent carton. Such pouches take up less storage space and the waste disposal costs are reduced, resulting in environmental advantages of pouches over cartons.

Laminates comprising hydroxy-phenoxyether polymers may be used in various applications and end-use markets, including meat/poultry trays, fish wrap/trays, candy and gum wrappers, fast food wrappers, dairy product packaging, flower wrap, and grease barrier films. Such laminates may be waterproof or oil resistant, or act as a barrier to flavor or odor.

A preferred laminate displays synergism as compared to the individual components of the laminate. The term ‘synergism,’ as used herein, is a broad term and is used in its ordinary sense, including, without limitation, interactions between parts that produce a result that is greater than the sum of the individual effects. For instance, a preferred laminate may display synergism by exhibiting a physical property which is greater than would be expected based on the rule of mixtures, on a weight basis. More preferably, a laminate displays synergistic strength, that is, it has greater strength, most preferably flexural strength, than the sum of the corresponding strengths of each of its individual components, adjusted for the weights of the components in the laminate. Interlayer-addition of hydroxy-phenoxyether polymer by coating or foam application may also be used in the production of spirally wound paper tubes, cores and containers. The hydroxy-phenoxyether polymer may act as both inter-layer adhesive and reinforcing agent to improve strength and rigidity.

In a further embodiment of the present invention, hydroxy-phenoxyether polymer is used as a corrugating adhesive. In this embodiment, hydroxy-phenoxyether polymer is used to laminate or adhere a flat sheet or web to a fluted corrugating medium. Hydroxy-phenoxyether polymer as the sole component or as one of the components of a multi-component corrugating adhesive provides significant benefits, including, but not limited to: improved rigidity when wet; recyclability; improved cyclic humidity performance; improved holdout on flute tips; reduced moisture in the glue line; improved rheology resulting in better registration at the point of bonding; reduced blistering especially in litho laminating; increased set speed; better lay-flat; reduced wash-boarding; better wet tack development allowing increased speed without delamination in the die cutter. Improved benefits may be achieved by applying the hydroxy-phenoxyether polymer adhesive using a Kohler ISO-BAR glue machine, (manufactured by Kohler Coating Machinery Corporation of North Canton, Ohio) especially on mini-flute, including E & F flute, and micro-flute, including N flute, corrugated substrates.

Any of the methods of addition of hydroxy-phenoxyether polymer described herein may be used to improve the moisture resistance and rigidity-when-wet of corrugated containers by the incorporation of hydroxy-phenoxyether polymer into the linerboard or fluting medium from which such containers are made. Use of hydroxy-phenoxyether polymers in corrugated containers has the added benefit of making such containers better suited for recycling. In conventional corrugated containers, stiffness improvement, especially rigidity-when-wet, is achieved by wax treatment. Wax treatment makes such containers less desirable for recycling because wax interferes with bonding, making the recycled paper produced from such containers weak. The wax also decreases the Coefficient of Friction (COF) in recycled boxes prepared from such containers, creating problems in converting and handling the recycled boxes. Hydroxy-phenoxyether polymer-treated corrugated containers do not suffer from these problems.

The Coated Substrate

The above-mentioned methods may be used to prepare a coated substrate having superior properties when compared to the uncoated substrate. When the substrate comprises paper, the amount of hydroxy-phenoxyether polymer coated onto the paper of the preferred embodiments is generally selected to be effective to provide the paper with a desirable property such as increased sizing and/or strength. Such coated substrates are evaluated by the apparent density, which is the weight of polymer plus fiber per unit volume of the web. The apparent density is controlled by web pressing, polymer solids, and heat/mold pressing.

Preferred amounts of hydroxy-phenoxyether polymer in the coated paper may be in the range of from about 0.01% to about 50%, more preferably about 0.1% to about 30%, even more preferably about 2% to about 20%, most preferably about 5% to about 15%, by weight based on total weight of the coated paper, depending on the particular application and the degree of sizing, strength or other property desired.

Preferably, the coated paper has an increase in sizing that is manifested as a decrease in Cobb value of about 5% or more, as compared to a comparable paper that does not contain a hydroxy-phenoxyether polymer. As used herein, a ‘comparable paper’ does not contain a hydroxy-phenoxyether polymer, but is in all other meaningful respects substantially identical to the paper containing the hydroxy-phenoxyether polymer that is the subject of the test. For instance, if a comparable paper has a Cobb value of 100 g/m², then a paper having an increase in sizing that is manifested as a decrease in Cobb value of about 5% or more has a Cobb value that is (100−(100×0.05))=95 g/m² or less. Preferably, the paper has a Cobb value of 500 g/m² or less, more preferably 100 g/m² or less, and most preferably 40 g/m² or less. Most papers that are sized have Cobb values of 100 g/m² or less.

Hydroxy-phenoxyether polymer may be coated onto paper to provide that paper with an increase in strength. The term ‘strength’, as used herein, is a broad term and is used in its ordinary sense, including, without limitation, resistance to rupture under an applied load. It may include one or more of the following and may be measured dry or wet: tensile strength and total energy absorption, bending resistance or flexural strength, compressive strength, folding endurance, and resistance to burst, tear or surface abrasion. Preferably, the paper has an increased dry tensile strength and/or an increased wet tensile strength of about 5% or more, more preferably 10% or more. The magnitude of an increase in strength may be determined by comparison to a comparable paper as defined above, using test methods well known to those skilled in the art.

For foods such as baked goods, it is often preferable for the packaging to have a certain degree of breathability or permeability in order to allow the moisture content to change in an amount that is effective to preserve freshness and crispness. However, staleness of the baked goods may result if the packaging is overly permeable. Permeability is desirable in coated paperboard distribution packaging for fresh cakes in Europe, as well as popcorn in the United States. It is also desirable in bag papers to allow air to escape when filling with powders, such as, for example, cement, sugar, or tea, or in microwave popcorn bags to permit steam to exit. The inventors have found that the permeability of the paper or paperboard may be adjusted by controlling the amount of hydroxy-phenoxyether polymer incorporated therein. Relative to comparable paper as defined above, the paper preferably exhibits lower permeability to gases such as oxygen, nitrogen, carbon dioxide, and/or water vapor. Most preferably, the amount of hydroxy-phenoxyether polymer coated onto the paper is effective to allow the desired degree of gas permeability, depending on the particular application.

For food packaging and non-food applications, such as ream and roll wrapper, resistance to moisture or water vapor and oxygen transmission is important. Hydroxy-phenoxyether polymer may be used in such applications to improve moisture or water vapor and oxygen transmission. Water Vapor Transmission Resistance (WVTR) and Moisture Vapor Transmission Resistance (MVTR) is measured by the TAPPI Test Method T 523 om-93 entitled “Dynamic Measurement of Water Vapor Transfer Through Sheet Materials.” Depending upon the application, testing may be done under hot and humid conditions (38° C. and 90±2% R.H.) or normal conditions (23° C. and 50±2% R.H.). Typical values for various products include 10 g/m² for ream wrapper, 5 g/m² for detergent boxes and 15 g/m² for bakery boxes. Oxygen resistance is reported as Oxygen Transmission Rate (OTR) and is measured by the Mocon instrument. Typical values for various products include <250 cm³/m²/day for keep-fresh boxes, <200 cm³/m²/day for OTR bag paper, and <100 cm³/m²/day for high OTR barrier paper.

The coated paper described herein may be shaped, processed or incorporated into semi-finished or finished manufactured items such as writing paper, drawing paper, paper towels, tissues, paper bags, paper boxes, photo paper, glossy paper, cardboard, corrugated cardboard, cardboard boxes, disposable diapers, adhesive labels, honeycomb structures, mailing tubes, sandpaper, and packaging material, by processes and methods generally known to those skilled in the art.

When a substrate other than paper is coated, the resulting coated substrate may exhibit improved properties including improved strength. One benefit to using hydroxy-phenoxyether polymer rather than lignosulfonate to improve the strength of containerboard and other pape!board is that the hydroxy-phenoxyether polymer imparts strength while providing a printable surface without discoloring or darkening the treated paperboard or containerboard, as lignosulfonate does.

In the case of sheets, the relationship between the tensile strength and the density of the sheet is linear regardless of the polymer concentration in the saturation both as saturation is a function of the absorption of the polymer. Drying may be an important step in creating a uniform polymer distribution. In one preferred embodiment, the drying temperature is similar to the melting point of the polymer. In general, polymer addition by impregnation may significantly alter the load-elongation properties, modulus, tensile and elongation. These effects depend on the type of polymer, fiber and the interaction of the polymer with the fiber and the mode of addition. The possible locations of the fiber polymer interactions include interfiber bond, bonding within the cell wall of the fiber (for those fibers made from cellular materials), bonding along the surface of the fiber, and bridging networks between fibers.

The coated substrates and laminates of preferred embodiments are suitable for use in a variety of current end-use applications including, but not limited to: paper, including structural paper which exhibits increased tensile strength, tear resistance and water repellency, among other properties, and may be formed into envelopes, pouches, food and beverage containers and other such articles; molded fiber articles and sheets (either foamed or unfoamed) which exhibit superior cushioning and insulating properties when used in protective packaging, boxes, trays and containers for packaging of products, including moisture or oxygen sensitive products and foods; foamed cartons; void fill boxes, and the like.

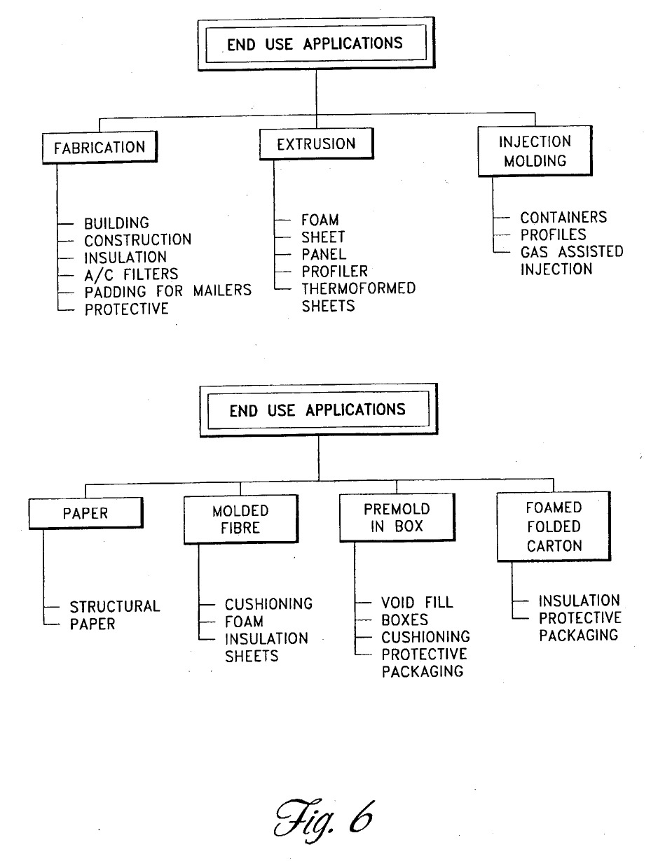

In addition to the above end-use applications, the coated substrates and laminates of preferred embodiments are also useful in numerous other end-use applications including, but not limited to: fabricated materials including building, construction, insulation, air conditioning filter, padding for mailers, and protective packaging; extruded materials including foam, sheets, panels, profiles, and thermoformed sheets; and materials made using injection techniques, including gas assisted injection, such as containers, trays, and profiles. A chart summarizing the various end use applications is provided in FIG. 6.

Use of the coated substrates and laminates of preferred embodiments provides advantages in the end-use applications over traditional paper or pulp/fiber based materials. Such advantages include, but are not limited to improvements in wet strength, water resistance/repellence, structural strength, elongation, elasticity, modulus, mechanical strength, cushioning properties, and insulating properties. In addition, the articles formed from composite may be recyclable.

A synergistic effect may be observed for extrusion lamination or extrusion coating of a hydroxy-phenoxyether polymer onto a substrate. For example, when an extruded hydroxy-phenoxyether polymer film is laminated to hydroxy-phenoxyether polymer-treated paperboard using a heated press, the laminated paperboard demonstrates superior strength properties when compared to an extruded hydroxy-phenoxyether polymer film laminated to a non-treated paperboard. An added benefit of such laminated paperboards is that the laminated construction is repulpable with addition of acetic acid.

A primary application for extrusion lamination using hydroxy-phenoxyether polymer is recyclable roll wrapper and header stock. At the present time, most producers of roll wrapper use polyethylene extrusion lamination of two linerboard webs. The resultant lamination achieves the necessary level of MVTR but is not recyclable. Printers may dispose of the non-recyclable roll wrappers and headers by landfill or burning, both of which are undesirable from an environmental standpoint. Recyclable roll wrapper may be produced using proprietary aqueous coatings, such as those supplied by Michelman Inc. of Cincinnati, Ohio or Retec Inc. of Granby, Quebec, Canada. However, two or three separate rod coatings are required, such as a primer for either or both of the two webs plus application of a barrier laminating adhesive formulation. These proprietary methods also require installation not only of new coating stations but also expensive new dryers. Use of hydroxy-phenoxyether polymer to produce roll wrapper and header stock allows use of currently installed equipment to make recyclable, environmentally benign products.

Recycling Methods

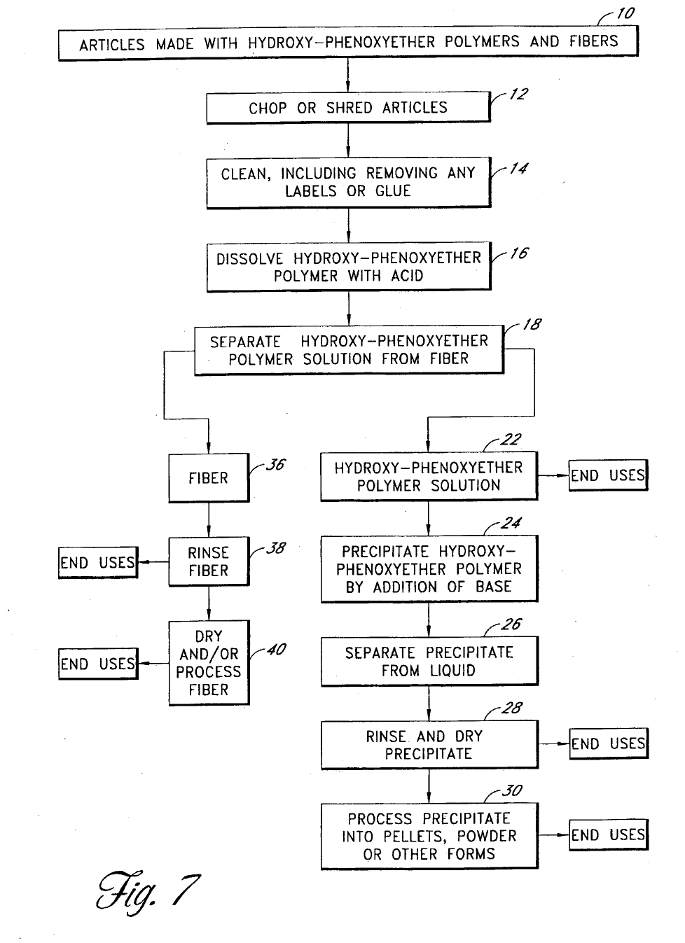

In accordance with one preferred embodiment, the hydroxy-phenoxyether polymer used in methods and materials disclosed herein comprises at least some recycled hydroxy-phenoxyether polymer. One method for obtaining recycled hydroxy-phenoxyether polymer is that in FIG. 7, a flow chart showing a preferred process for obtaining recycled hydroxy-phenoxyether polymer and fiber from articles 910 made with various fibers and hydroxy-phenoxyether polymers. The method noted below may also be used to recycle other materials which comprise cellulose or other fibers and hydroxy-phenoxyether polymer whether or not such materials may be appropriately designated as ‘paper.’ Other processes and additional details not necessary to repeat here are disclosed in Assignee's copending application entitled RECYCLING OF ARTICLES COMPRISING HYDROXY-PHENOXYETHER POLYMERS, application Ser. No.______ [Attorney Docket No. APTLTD.021A], filed on the same date as the present application, the entirety of which is hereby incorporated by reference.

As noted in FIG. 7, the first portions of the method relate to preparation of the articles to be recycled. The first step relates to breaking the articles down into smaller pieces or ‘flakes’ 912. Because some of the articles containing materials to be recycled are relatively large, the articles are preferably granulated, chopped, shredded, comminuted, grated, or otherwise made into smaller pieces. The size of such pieces is not important.

The second part of the process is cleaning 914. The recycled articles often contain dirt, food particles, grease, labels, adhesive, or other items or debris attached to them which should be removed by cleaning. Cleaning may be accomplished by steam treatment in an aspirator, caustic wash, washing with water either with or without cleaning solution, or treatment by solvents or cleaning solutions not in the presence of water. Preferred cleaning solutions are those which do not dissolve the hydroxy-phenoxyether polymers, e.g. those which are neutral or basic in character or not good solvents for the plastic. Following exposure to the cleaning agents, the materials are optionally rinsed and/or dried before proceeding with the process.

Following preparation, the flakes are combined with an aqueous solution containing about 1-50%, more preferably about 5-20% acetic acid by weight 916. The pH of the solution is preferably below pH 4, more preferably about pH 3.0-3.5 or less. The flakes are combined with the acid solution for a time period sufficient to result in dissolution of the hydroxy-phenoxyether polymer, preferably for about 0.5 to 5 hours at about 25-95° C. with stirring or agitation.

Following dissolution of the hydroxy-phenoxyether polymer, the hydroxy-phenoxyether polymer solution 922 is separated from the other materials in the mixture, primarily fiber 936. The separation 918 is preferably done by filtration, but may be done by any method capable of separating solids and liquids such as decantation, centrifugation or settling. The hydroxy-phenoxyether polymer acidic solution may be used following separation in the form of a solution. Alternatively, the acidic hydroxy-phenoxyether polymer solution may undergo additional treatment to partially or fully precipitate the hydroxy-phenoxyether polymer from the solution to give a dispersion or solid.

Precipitation 924, whether partial or complete, is done by addition of one or more basic (alkaline) materials. Preferably, the basic compound is a strong base such as sodium hydroxide or potassium hydroxide in the form of a solution. As the base is added, the pH of the solution will begin to rise. As the pH of the solution approaches pH 4, precipitate may begin to form. As the pH rises above pH 4, the amount of precipitate increases, with more precipitate forming at pH 5 and pH 6, until at about pH 7 at which point precipitation is substantially complete.

Following precipitation, the hydroxy-phenoxyether polymer is separated 926 from the liquid component or mother liquor from which the precipitate formed. The solids may be separated from the liquid by any method capable of separating solids and liquids, preferably filtration, decantation, centrifugation or settling. The hydroxy-phenoxyether polymer precipitate is preferably rinsed 928 to remove any salts or other materials which may deposit on the precipitate from the liquid portions. Preferred rinsing media include water, preferably distilled and/or deionized water, and solvents in which the hydroxy-phenoxyether polymer is insoluble or only marginally soluble, with water being preferred. The rinse water may be heated to aid the dissolution of residues on the precipitate. The precipitate is then dried 928. Drying may be accomplished by air drying, vacuum drying with or without added heat, oven drying, IR lamp drying, desiccants, or other methods which aid in the evaporation or elimination of water.

The precipitate may be used following drying or it may be processed 930 before use. Further processing of the precipitate prior to use includes, without limitation, pulverization to form a powder and extrusion to form sheets or pellets. Such processing may include the addition of one or more additives. Suitable additives include, without limitation, mold release agents, dyes, and lubricants. The additives may be dry mixed with the hydroxy-phenoxyether polymer or added to a melt of the hydroxy-phenoxyether polymer.

Following separation from the acidic hydroxy-phenoxyether polymer solution, the fiber is preferably rinsed 938 with water. The rinse water is preferably deionized and/or distilled, and either neutral or slightly acidic so as to deter precipitation of any hydroxy-phenoxyether polymer onto the fiber during rinsing. In accordance with one preferred embodiment, the fiber is first rinsed with an acidic solution having a pH below about pH 4, followed by a second rinse with water having a pH at or near neutral.

The fiber may then be treated by drying or further processing 940. Drying of the fiber is done by a method such as air drying, vacuum drying with or without added heat, oven drying, IR lamp drying, desiccants, or another method which aids in the evaporation or elimination of water. Further processing may be done to influence properties of the fiber which may enhance its ability to bind with hydroxy-phenoxyether polymer. Such methods are discussed elsewhere herein, and may be done either before or after drying.

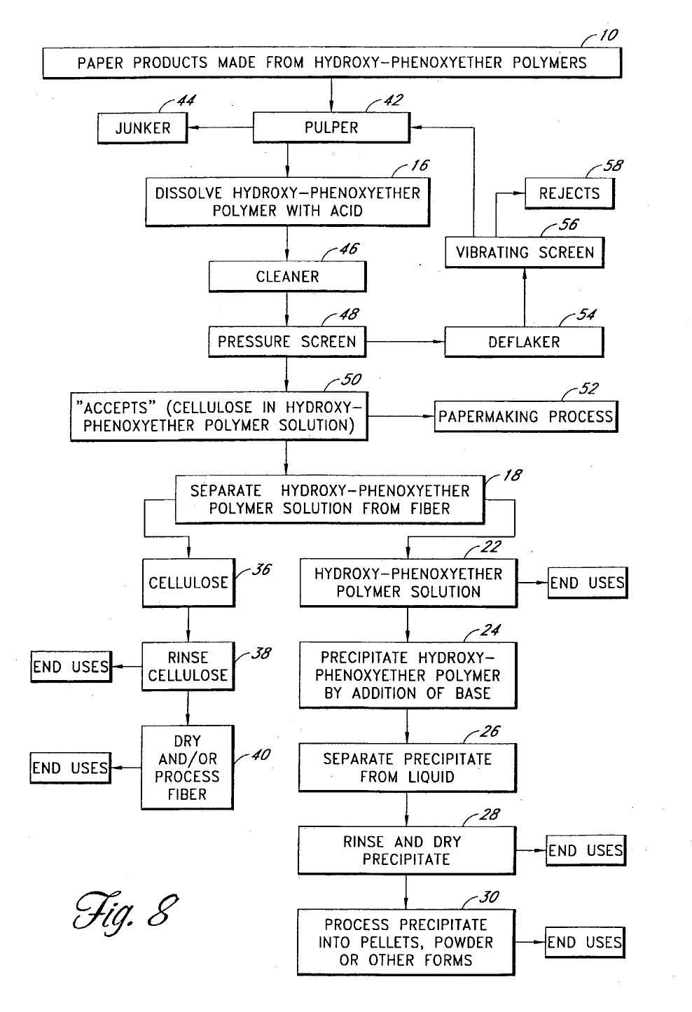

Paper and other articles treated with lower levels of hydroxy-phenoxyether polymer for sizing and lower levels of dry or wet strength may be treated as part of a conventional paper mill recycling system, enabling the cellulose or other such fibers to be recovered and reused without recycling the polymer. If, however, the article or paper has higher levels of hydroxy-phenoxyether polymer or if recycling of the hydroxy-phenoxyether polymer is desired, a preferred method for such recycling is shown in FIG. 8. Referring to FIG. 8, there is an alternate method of recycling articles made from fiber and hydroxy-phenoxyether polymer, described in terms of a preferred embodiment using paper made from cellulose.

Paper for recycling is usually baled and brought to the mill. The bales are dropped into the pulper 942, a large vat containing water and fitted with a high-shear agitator. The combination of wetting and mechanical action breaks the hydrogen bonds amongst the cellulose fibers to make a pulp slurry. The water in the pulper is acidified 916, as discussed above, to dissolve the hydroxy-phenoxyether polymer. Baling wires and other gross contaminants are removed from the pulper by a ‘junker’ 944. The pulp and hydroxy-phenoxyether polymer solution is discharged from the pulper and then cleaned 946 and screened 948 to further remove contaminants. The good fiber together with the hydroxy-phenoxyether polymer solution, ‘accepts’ 950, may be processed to make paper 952 or they may undergo a separation process 918. Preferably, separation of the cellulose fibers and hydroxy-phenoxyether polymer solution, and any further processing of the fibers and/or hydroxy-phenoxyether polymer solution proceeds as discussed above.

Materials which are not ‘accepts’ pass into the deflaker 954 and then through a vibrating screen 956. Any usable pulp material is then redeposited in the pulper 942 with the remaining undesirable materials being discarded as ‘rejects’ 958.

### EXAMPLE 1

Paper may be coated with any thermoplastic material to give a barrier material that provides protection against moisture and oxygen and gives heat sealability. However, some do not offer increased strength and resilience with repeated handling as may be achieved with PHAE BLOX® resin.

A carton board type material is produced containing two layers, including a thin layer of white paper over a thicker layer of partly bleached, mixed mechanical and chemical pulp. These layers are laminated together with the PHAE BLOX® resin using an extrusion coating process. The resulting carton board is tested for moisture permeability, oxygen permeability, water repellency, strength and resilience. The results are compared with carton boards produced with other thermoplastic resins.

While all resins are able to offer a moisture and oxygen barrier, the PHAE BLOX® resin has the advantage of increasing strength and resilience. Carton board is used in many major high quality food, cosmetic, and medical packages where barrier properties are very important. Some existing packages on the market have been found to give low oxygen transmission rates, but rapid deterioration of the packaged product is noted either due to the cracks in package appearing as a result of external flexing during handling, or abrasion from inside by the packaged product. Packaging materials comprising the BLOX resin as a laminate or surface coating do not suffer from these problems to the same degree as prior art coatings.

In this example, the resin not only acts as a barrier to moisture and oxygen, it also eliminates the need for an adhesive between the two layers, thereby reducing material and processing costs.

### EXAMPLE 2

The properties of a PHAE-coated paper sample and a metallized film are compared. The metallized film has excellent oxygen and moisture barrier properties. However, on flexing, the film develops tiny pinholes which subsequently diminish the barrier properties of the film appreciably. The PHAE-coated paper also exhibits good barrier properties, but does not develop pinholes or cracks upon flexing, and therefore maintains its barrier properties. Many products currently packaged in foil do not require the high barrier properties of metallized film. Therefore, because such PHAE coated paper offers good barrier properties and is much less costly to produce, it may find an application in packages wherein the extreme barrier properties of foil are non-essential.

The above description discloses several methods and materials of the present invention. This invention is susceptible to modifications in the methods and materials, such as the choice of polymer chemistry, substrate, polymer form, additives, fiber pretreatment methods, etc. used in the coated materials and laminates, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims.

What is claimed is:

1. A laminate comprising a first layer, a second layer adjacent to the first layer, and a bond therebetween, wherein the first layer comprises a hydroxy-phenoxyether polymer having a melting point, wherein the second layer comprises cellulosic fibers, and wherein the bond is formed by partially or fully melting the first layer while the first layer is in contact with the second layer, then cooling the layers to below the melting point of the first layer.

2. The laminate of claim 1, wherein the hydroxy-phenoxyether polymer comprises a polyhydroxy-amino ether.

3. The laminate of claim 1, wherein the hydroxy-phenoxyether polymer comprises a recycled hydroxy-phenoxyether polymer.

4. The laminate of claim 3, wherein the recycled hydroxy-phenoxyether polymer comprises more than about 10 wt. % of the hydroxy-phenoxyether polymer.

5. The laminate of claim 1, further comprising at least one additional layer, the additional layer comprising a material selected from the group consisting of nonwoven fiber, woven fiber, web, solid foam, and solid sheet.

6. The laminate of claim 1, further comprising at least one additional layer, the additional layer comprising a material selected from the group consisting of metal, glass, ceramic, polymer, and cellulosic material.

7. A coated sheet comprising a substrate and a coating, wherein the substrate comprises a sheet of cellulosic fibers and the coating comprises a hydroxy-phenoxyether polymer, and wherein a bond is formed between the hydroxy-phenoxyether polymer and the cellulosic fibers.

8. The coated sheet of claim 7, wherein the hydroxy-phenoxyether polymer comprises a polyhydroxy-amino ether.

9. The coated sheet of claim 7, wherein the hydroxy-phenoxyether polymer comprises a recycled hydroxy-phenoxyether polymer.

10. The coated sheet of claim 9, wherein the recycled hydroxy-phenoxyether polymer comprises more than about 10 wt. % of the hydroxy-phenoxyether polymer.

11. A laminate comprising a hydroxy-phenoxyether polymer, wherein a layer of the laminate is bonded to an adjacent layer of the laminate, and wherein the hydroxy-phenoxyether polymer contributes to a bond between the layer and the adjacent layer.

12. The laminate of claim 11, wherein a layer comprises a material selected from the group consisting of nonwoven fiber, woven fiber, web, solid foam, and solid sheet.

13. The laminate of claim 11, wherein a layer comprises a material selected from the group consisting of metal, glass, ceramic, polymer, and cellulosic material.

14. A composition comprising a solid substrate and a coating, wherein the coating comprises a hydroxy-phenoxyether polymer, the coating being applied directly to the substrate in a liquid form selected from the group consisting of molten polymer, plastisol, non-aqueous solution, and non-aqueous dispersion, and wherein a bond is formed between the hydroxy-phenoxyether polymer and the substrate.

15. The composition of claim 14, wherein the substrate comprises a material selected from the group consisting of nonwoven fiber, woven fiber, web, solid foam, and solid sheet.

16. The composition of claim 14, wherein the substrate comprises a material selected from the group consisting metal, glass, ceramic, polymer, and cellulosic material.

17. A method for preparing a laminate comprising a hydroxy-phenoxyether polymer, the method comprising:
providing a substrate, wherein the substrate comprises a material selected from the group consisting of nonwoven fiber, woven fiber, web, solid foam, and solid sheet;
providing a hydroxy-phenoxyether polymer, wherein the polymer comprises a solid form selected from the group consisting of particle, nonwoven fiber, woven fiber, web, solid foam, and solid sheet;
contacting the hydroxy-phenoxyether polymer to the substrate;
forming a bond between the hydroxy-phenoxyether polymer and the substrate; and
recovering a laminate comprising the hydroxy-phenoxyether polymer and the substrate.

18. The method of claim 17, wherein forming a bond between the hydroxy-phenoxyether polymer and the substrate comprises partially or fully melting the hydroxy-phenoxyether polymer, such that a thermal bond between the hydroxy-phenoxyether polymer and the substrate is formed.

19. The method of claim 17, wherein contacting the hydroxy-phenoxyether polymer to the substrate and forming a bond between the hydroxy-phenoxyether polymer and the substrate comprises contacting the hydroxy-phenoxyether polymer in a molten form with the substrate, such that a thermal bond between the hydroxy-phenoxyether polymer and the substrate is formed.

20. A method for coating a substrate with a hydroxy-phenoxyether polymer, the method comprising:
providing a substrate, wherein the substrate comprises a material selected from the group consisting of nonwoven fiber, woven fiber, web, solid foam and solid sheet;
providing a hydroxy-phenoxyether polymer, wherein the polymer comprises a liquid form selected from the group consisting of molten polymer, plastisol, non-aqueous solution, and non-aqueous dispersion;
applying the hydroxy-phenoxyether polymer to the substrate, whereby the hydroxy-phenoxyether polymer is adhered to the substrate; and
recovering a coated substrate comprising the hydroxy-phenoxyether polymer.

21. The method of claim 20, wherein applying the hydroxy-phenoxyether polymer to the substrate comprises a coating method selected from the group consisting of roll coating, gravure coating, dip saturation coating, fountain coating, blade coating, rod coating and air knife coating.

22. The method of claim 20, wherein the liquid form comprises a non-aqueous solution or a non-aqueous dispersion, and applying the hydroxy-phenoxyether polymer to the substrate comprises a coating method selected from the group consisting of spray coating, foam addition coating, and impregnation coating.
